(19) United States
(12) Patent Application Publication
(10) Pub. No.: US 2018/0309533 A1
(43) Pub. Date: Oct. 25, 2018

(54) BASE STATION APPARATUS, TERMINAL APPARATUS, AND COMMUNICATION METHOD

(71) Applicant: SHARP KABUSHIKI KAISHA, Sakai City, Osaka (JP)

(72) Inventors: TAKASHI YOSHIMOTO, Sakai City (JP); RYOTA YAMADA, Sakai City (JP); YASUHIRO HAMAGUCHI, Sakai City (JP)

(21) Appl. No.: 15/770,850

(22) PCT Filed: Sep. 15, 2016
(86) PCT No.: PCT/JP2016/077212

§ 371 Date: Apr. 25, 2018

(30) Foreign Application Priority Data
Nov. 2, 2015 (JP) 2015-215431

(51) Int. Cl. H04J 11/00; H04W 56/00; H04W 72/04

(52) U.S. Cl. CPC H04J 11/0073; H04W 72/0453; H04J 11/0079; H04W 56/002

(57) ABSTRACT

To provide a base station apparatus, a terminal apparatus, and a communication method capable of cell search with an accuracy meeting a required condition for each of the radio parameter sets. There are provided a radio reception unit configured to receive downlink signals in a frequency band, the frequency band being constituted by a region of a first radio parameter set and a region of a second radio parameter having a subcarrier spacing different from that of the first radio parameter set, and a synchronization detecting unit configured to establish synchronization with the base station apparatus in the frequency band. A synchronization signal sequence of the first radio parameter set is mapped to the region of the first radio parameter set, and a synchronization signal sequence of the second radio parameter set is mapped to the region of the second radio parameter set. The synchronization detecting unit detects synchronization with the base station apparatus in the frequency band by using the synchronization signal sequence of the first radio parameter set and the synchronization signal sequence of the second radio parameter set.

### TECHNICAL FIELD

The present invention relates to a base station apparatus, a terminal apparatus, and a communication method.

### BACKGROUND ART

In a Radio Access Network (RAN) such as Long Term Evolution (LTE) or LTE-Advanced (LTE-A) standardized by the Third Generation Partnership Project (3GPP), the communication area can be widened by taking a cellular configuration in which areas covered by base station apparatuses or transmission stations equivalent to the base station apparatuses are arranged in the form of multiple cells (Cells). In this cellular configuration, a terminal apparatus performs a Cell search procedure to detect a cell ID and acquire frame synchronization and symbol synchronization. For the cell search, a Synchronization Channel is arranged in a downlink radio frame (NPL 1).

In recent years, in order to support multiple use cases such as Mobile Broadband (MBB) and Machine Type Communication (MTC), a new Radio Access Technology (RAT) has been considered (NPL 2). This radio access technology is designed to meet a wide range of required conditions such as data rate, system capacity, latency, and mobility to address these use cases. For this end, used in this radio access technology are multiple radio parameter sets of a wide range of multiple frequency bands (several hundreds MHz to several tens GHz) and multiple frequency bandwidths (several KHz to several hundreds MHz), or the like.

### CITATION LIST

### Non-Patent Literature

NPL 1: “3rd Generation Partnership Project Technical Specification Group Radio Access Network: Evolved Universal Terrestrial Radio Access (E-UTRA): Physical channels and modulation” 3GPP TS36.211 v12.3.0 (2014-3).
NPL 2: “5G Vision for 2020 and Beyond” RWS-150051, 3GPP RAN Workshop on 5G, (2015-9)

### SUMMARY OF THE INVENTION

### Problem to be Solved by the Invention

However, in a radio access network described in NPL 1, the Synchronization Channel is arranged in a downlink radio frame in order to perform an optimal cell search in the radio access technology using a certain system bandwidth. For this reason, in the radio access technology using a wide range of multiple radio parameter sets, it is necessary to design a Synchronization Channel on which the terminal apparatus can accurately perform the cell search for each of the radio parameter sets.

The present invention has been made in consideration of such a circumstance, and has an object to provide a base station apparatus, a terminal apparatus, and a communication method capable of efficient cell search in a radio access technology using multiple different radio parameter sets with an accuracy meeting a required condition for each of the radio parameter sets

### Means for Solving the Problem

To address the above-mentioned problems, a base station apparatus, a terminal apparatus, and a communication method according to an aspect of the present invention are configured as follows.

A terminal apparatus according to an aspect of the present invention includes a radio reception unit configured to receive downlink signals in a frequency band, the frequency band being constituted by a region of a first radio parameter set and a region of a second radio parameter having a subcarrier spacing different from a subcarrier spacing of the first radio parameter set, and a synchronization detecting unit configured to establish synchronization with the base station apparatus in the frequency band, in which a synchronization signal sequence of the first radio parameter set is mapped to the region of the first radio parameter set, and a synchronization signal sequence of the second radio parameter set is mapped to the region of the second radio parameter set, and the synchronization detecting unit detects synchronization with the base station apparatus in the frequency band by using the synchronization signal sequence of the first radio parameter set and the synchronization signal sequence of the second radio parameter set.

In the terminal apparatus according to an aspect of the present invention, in a case that the synchronization detecting unit establishes synchronization by using the synchronization signal sequence of the first radio parameter set, the reception unit receives information on a synchronization signal sequence of the second parameter set included in the downlink signals mapped to the region of the first radio parameter set, and the synchronization detecting unit detects synchronization in the region of the second parameter set by using the information on the synchronization signal sequence of the second parameter set.

In the terminal apparatus according to an aspect of the present invention, in a case that the synchronization detecting unit establishes synchronization by using the synchronization signal sequence of the first radio parameter set, the radio reception unit uses the synchronization established by using the synchronization signal sequence of the first radio parameter set to receive downlink signals transmitted by the base station apparatus, in the region of the first radio parameter set and the region of the second radio parameter set.

In the terminal apparatus according to an aspect of the present invention, the synchronization signal sequence of the second radio parameter set is a sequence obtained by combining the synchronization signal sequences of the multiple first radio parameter sets, and the synchronization signal sequence of each of the first radio parameter sets constituting a synchronization signal of the second radio parameter set is any sequence of multiple synchronization signal sequence candidates, and the synchronization signal detecting unit detects a cell ID of the second radio parameter set from a series of synchronization signal sequences obtained by combining the synchronization signal sequences of the multiple first radio parameter sets.

In the terminal apparatus according to an aspect of the present invention, in a case that the subcarrier spacing of the first radio parameter set is a times the subcarrier spacing of the second radio parameter set, the synchronization detecting unit detects synchronization in the region of the second radio parameter set by using the number of OFDM symbols which is a times the number of OFDM symbols that the synchronization signal sequence of the first radio parameter set is mapped.

In the terminal apparatus according to an aspect of the present invention, the synchronization detecting unit uses the number of subcarriers that is the same as the number of subcarriers used to detect synchronization in the region of the first radio parameter set to detect synchronization in the region of the second radio parameter set.

In the terminal apparatus according to an aspect of the present invention, the first radio parameter set and the second radio parameter set is one radio access technology.

A communication method of a terminal apparatus according to an aspect of the present invention includes the steps of receiving downlink signals in a frequency band, the frequency band being constituted by a region of a first radio parameter set and a region of a second radio parameter set having a subcarrier spacing different from a subcarrier spacing of the first radio parameter set, and establishing synchronization with the base station apparatus in the frequency band, in which a synchronization signal sequence of the first radio parameter set is mapped to the region of the first radio parameter set, and mapping a synchronization signal sequence of the second radio parameter set to the region of the second radio parameter set, and the detecting detects synchronization with the base station apparatus in the frequency band by using the synchronization signal sequence of the first radio parameter set and the synchronization signal sequence of the second radio parameter set.

A base station apparatus according to an aspect of the present invention includes a synchronization signal generation unit configured to generate a synchronization signal sequence of a first radio parameter set and a synchronization signal sequence of a second radio parameter set, a multiplexing unit configured to, in a frequency band constituted by a region of the first radio parameter set and a region of the second radio parameter set having a subcarrier spacing different from a subcarrier spacing of the first radio parameter set, map the synchronization signal sequence of the first radio parameter set to the region of the first radio parameter set and map the synchronization signal sequence of the second radio parameter set to the region of the second radio parameter set, a radio transmission unit configured to transmit the synchronization signal sequence of the first radio parameter set and the synchronization signal sequence of the second radio parameter set to the terminal apparatus, and a radio reception unit configured to receive an uplink signal from the terminal apparatus, in which in a case that the radio reception unit receives information indicating that synchronization is established in any radio parameter set, the radio transmission unit transmits information on a synchronization signal sequence of other radio parameter set than the radio parameter set specified by the information indicating that the synchronization is established.

A base station apparatus according to an aspect of the present invention includes a synchronization signal generation unit configured to generate a synchronization signal sequence of a first radio parameter set and a synchronization signal sequence of a second radio parameter set, a multiplexing unit configured to, in a frequency band constituted by a region of the first radio parameter set and a region of the second radio parameter set having a subcarrier spacing different from a subcarrier spacing of the first radio parameter set, map the synchronization signal sequence of the first radio parameter set to the region of the first radio parameter set and map the synchronization signal sequence of the second radio parameter set to the region of the second radio parameter set, and a radio transmission unit configured to transmit the synchronization signal sequence of the first radio parameter set and the synchronization signal sequence of the second radio parameter set to the terminal apparatus, in which the number of OFDM symbols that the synchronization signal sequence of the second radio parameter set is mapped by the multiplexing unit is configured to be more than the number of OFDM symbols that the synchronization signal sequence of the first radio parameter set is mapped.

In the base station apparatus according to an aspect of the present invention, in a case that the subcarrier spacing of the first radio parameter set is a times the subcarrier spacing of the second radio parameter set, the number of OFDM symbols that the synchronization signal sequence of the second radio parameter set is mapped is a times the number of OFDM symbols that the synchronization signal sequence of the first radio parameter set is mapped.

In the base station apparatus according to an aspect of the present invention, the number of subcarriers that the synchronization signal sequence of the first radio parameter set is mapped is the same as the number of subcarriers that the synchronization signal sequence of the second radio parameter set is mapped.

In the base station apparatus according to an aspect of the present invention, the number of subcarriers that the first radio parameter set is mapped is the same as the number of subcarriers constituting a system band of the second radio parameter set.

In the base station apparatus according to an aspect of the present invention, a frequency bandwidth that a synchronization signal of the first radio parameter set is mapped is the same as a frequency bandwidth that a synchronization signal of the second radio parameter set is mapped.

In the base station apparatus according to an aspect of the present invention, the synchronization signal generation unit generates the synchronization signal sequence of the second radio parameter set by combining synchronization signal sequences of multiple first radio parameter sets, and each of the synchronization signal sequences of the first radio parameter sets constituting the synchronization signal of the second radio parameter set is a synchronization signal sequence selected from multiple synchronization signal sequence candidates.

A communication method of a base station apparatus according to an aspect of the present invention includes the steps of generating a synchronization signal sequence of a first radio parameter set and a synchronization signal sequence of a second radio parameter set, in a frequency band constituted by a region of the first radio parameter set and a region of the second radio parameter set having a subcarrier spacing different from a subcarrier spacing of the first radio parameter set, mapping the synchronization signal sequence of the first radio parameter set to the region of the first radio parameter set and mapping the synchronization signal sequence of the second radio parameter set to the region of the second radio parameter set, transmitting the synchronization signal sequence of the first radio parameter set and the synchronization signal sequence of the second radio parameter set to the terminal apparatus, and receiving an uplink signal from the terminal apparatus, in which in a case that the receiving receives information indicating that synchronization is established in any radio parameter set, the transmitting transmits information on a synchronization signal sequence of other radio parameter set than the radio parameter set specified by the information indicating that the synchronization is established.

### Effects of the Invention

According to an aspect of the present invention, it is possible to perform efficient cell search in a radio access technology using multiple different radio parameter sets with an accuracy meeting a required condition for each of the radio parameter sets

### BRIEF DESCRIPTION OF THE DRAWINGS

FIG. 1 is a diagram illustrating an example of a communication system according to the present embodiment.

FIG. 2 illustrates examples of a radio parameter set in the communication system according to the present embodiment.

FIG. 3 is a diagram illustrating a configuration example of a radio frame in a radio access technology according to the present embodiment.

FIG. 4 is a diagram illustrating an arrangement example of each of multiple radio parameters according to the present embodiment.

FIG. 5 is a diagram illustrating an example of an OFDM subcarrier configuration according to the present embodiment.

FIG. 6 is a diagram illustrating another example of the OFDM subcarrier configuration according to the present embodiment.

FIG. 7 is a diagram illustrating a configuration example of OFDM symbols per a subframe in the radio access technology according to the present embodiment.

FIG. 8 is a diagram illustrating an arrangement example of a first synchronization signal according to the present embodiment.

FIG. 9 is a diagram illustrating another configuration example of the OFDM symbols per a subframe in the radio access technology according to the present embodiment.

FIG. 10 is a diagram illustrating another arrangement example of the first synchronization signal according to the present embodiment.

FIG. 11 is a diagram illustrating another arrangement example of the first synchronization signal according to the present embodiment.

FIG. 12 is a schematic block diagram illustrating a configuration of a base station apparatus according to the present embodiment.

FIG. 13 is a schematic block diagram illustrating a configuration of a terminal apparatus according to the present embodiment.

FIG. 14 is a diagram illustrating a cell search flow example for the terminal apparatus according to the present embodiment.

FIG. 15 is a diagram illustrating a sequence example of the cell search according to the present embodiment.

FIG. 16 is a diagram illustrating another example of the OFDM subcarrier configuration in an embodiment according to the present embodiment.

FIG. 17 is a diagram illustrating another example of the OFDM subcarrier configuration according to the present embodiment.

FIG. 18 is a diagram illustrating another configuration example of the OFDM symbols per a subframe in the radio access technology according to the present embodiment.

FIG. 19 is a diagram illustrating a subframe in which a synchronization signal is arranged in a radio frame.

### MODE FOR CARRYING OUT THE INVENTION

A communication system according to the present embodiment includes a base station apparatus (a transmission unit, cells, serving cells, a transmission point, a group of transmit antennas, a group of transmit antenna ports, component carriers, eNodeB) and terminal apparatuses (a terminal, a mobile terminal, a reception point, a reception terminal, a reception unit, a group of receive antennas, a group of receive antenna ports, UE). The base station apparatus and terminal apparatus described above can communicate in a licensed band and/or an unlicensed band.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

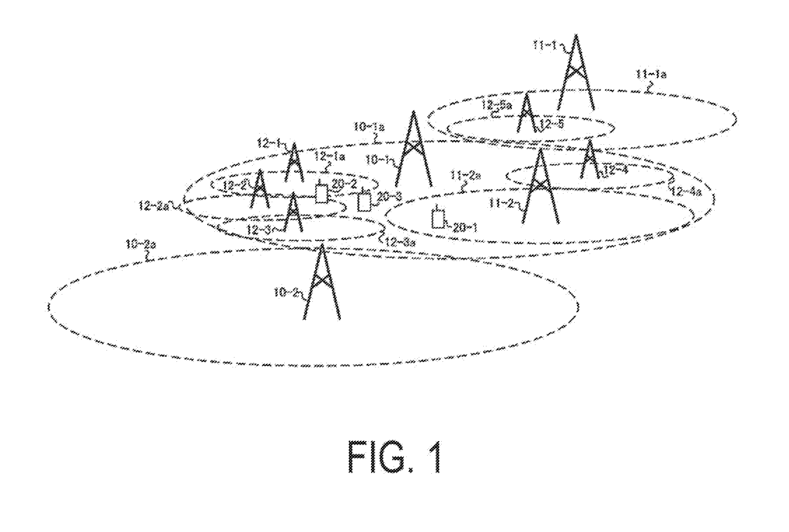

FIG. 1 is a diagram illustrating an example of a communication system according to the present embodiment. As illustrated in FIG. 1, the communication system according to the present embodiment includes base station apparatuses 10-1, 10-2, 11-1, 11-2, and 12-1 to 12-5, and terminal apparatuses 20-1 to 20-3. Coverages 10-1a, 10-2a, 11-1a, 11-2a, and 12-1a to 12-5a of the base station apparatuses are respectively ranges (communication areas) in which the base station apparatuses 10-1, 11-1, 11-2, and 12-1 to 12-5 can connect to the terminal apparatuses. Each of the coverages of the base station apparatuses is also referred to as a cell. The base station apparatuses 10-1 and 10-2 are also collectively referred to as base station apparatuses 10. The base station apparatuses 11-1 and 11-2 are also collectively referred to as base station apparatuses 11. The base station apparatuses 12-1 to 12-5 are also collectively referred to as base station apparatuses 12. The terminal apparatuses 20-1 to 20-3 are also collectively referred to as terminal apparatuses 20. The terminal apparatus 20 can connect to at least one of the base station apparatuses 10 to 12. Note that the number of installations of the base station apparatuses 10 to 12 constituting the communication system according to the present embodiment is not limited to that in FIG. 1.

The base station apparatuses 10 to 12 in the communication system according to the present embodiment can be located such that the coverages overlap each other. In the example of FIG. 1, the coverage 10-1a overlaps the coverages 11-2a, and 12-1a to 12-4a. The terminal apparatus 20-1 existing in both the coverage 10-1a and the coverage 11-1a can also simultaneously connect to the base station apparatuses 10-1 and 11-1. The coverages configured by the base station apparatuses 12 are densely arranged. The terminal apparatus 20-2 existing in the coverage 10-1a, the coverage 12-1a, and the coverage 12-2a can also simultaneously connect to the base station apparatuses 10-1, 12-1, and 12-2. For example, the communication system according to the present embodiment can adopt carrier aggregation, dual connectivity or the like as a simultaneously connecting method. In this case, a cell communicating with the terminal apparatus may be a Primary Cell (PCell), a Secondary Cell (SCell), or a Primary Secondary Cell (PSCell).

The communication system in FIG. 1 can adopt multiple heterogeneous radio access networks including existing radio networks.

The communication system in FIG. 1 can adopt multiple Radio Access Technologies (RATs). The multiple radio access technologies may be heterogeneous. There are mixedly, in the communication system in FIG. 1, the base station apparatuses that are different from each other in a supporting radio access network or radio access technology.

There are mixedly, in the communication system in FIG. 1, the terminal apparatuses that are different from each other in a supporting radio access network or radio access technology. For example, in a case that the base station apparatus 10-1 adopts a first radio access technology and a second radio access technology, and the base station apparatuses 10-2 and 10-3 adopt the first radio access technology, the terminal apparatus supporting only the first access technology can connect to the base station apparatuses 10-1 to 10-3. The terminal apparatus supporting only the second radio access technology is limited to connecting to the base station 10-1. The terminal apparatus supporting the first access technology and the second access technology can connect to the base station apparatuses 10-1 to 10-3.

The first radio access technology is configured by multiple radio parameter sets. The second radio access technology is configured by one radio parameter set. The base station apparatus 10-1 to base station apparatus 10-3 adopt different radio parameters from each other of the first radio access technology. The base station apparatus 10-1 can use each of the radio parameters constituting the first radio access technology in a system band of the base station apparatus 10-1. The radio parameter of the first radio access technology may have backward compatibility with one of the radio parameter sets constituting the second radio access technology.

The terminal apparatus is mixedly provided with the supporting radio parameter sets. The terminal apparatus supporting the first radio access technology uses all radio parameter sets constituting the first radio access technology to connect to the base station apparatus supporting the first radio access technology. The terminal apparatus supporting the second radio access technology uses the radio parameter set having the backward compatibility with the second radio access technology among the radio parameter sets constituting the first radio access technology to connect to the base station apparatus supporting the first radio access technology. Difference in the radio access network is associated with difference in the radio access technology.

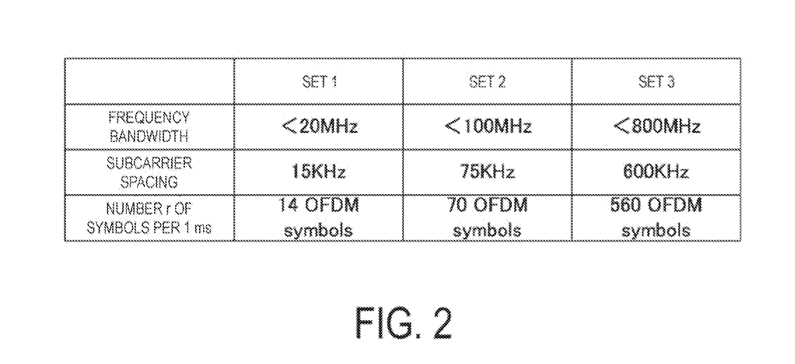

FIG. 2 illustrates examples of the radio parameter set in the first radio access technology according to the present embodiment. Each of the radio parameter sets is that in a case that Orthogonal Frequency Division Multiplexing (OFDM) or multicarrier is used. The radio parameter sets are different from each other in an available frequency bandwidth (system bandwidth), a subcarrier spacing, and the number of OFDM symbols per 1 ms. The radio parameter sets are different from each other in an OFDM symbol length. The radio parameter sets are different from each other in a sampling interval (sampling frequency). For example, a sampling interval in radio parameter set 2 is set to be shorter than a sampling interval in radio parameter set 1. A sampling interval in radio parameter set 3 is set to be shorter than the sampling interval in radio parameter set 2.

The radio parameter sets may be different from each other in the number of FFT points in the OFDM. The radio parameter sets can be adopted in the same frequency band/different frequency bands. For example, radio parameter set 1 is adopted in a band of less than 3 GHz, radio parameter set 2 is adopted in a band of 3 GHz or greater and less than 10 GHz, and radio parameter set 3 is adopted in a band of 10 GHz or greater. For example, in FIG. 1, radio parameter set 1 is adopted for radio communication between the base station apparatus 10 and the terminal apparatus. Radio parameter set 2 is adopted for radio communication between the base station apparatus 11 and the terminal apparatus. Radio parameter set 3 is adopted for radio communication between the base station apparatus 12 and the terminal apparatus.

The base station apparatus can adopt the respective radio parameter sets at the same carrier frequency or frequency band (system band). The base station apparatus can use multiple radio parameter sets in the same OFDM symbol.

FIG. 2 illustrates an example of one radio access technology constituted by multiple different radio parameter sets, and an aspect of the present invention is not limited to such parameter values. For example, the frequency bandwidth in radio parameter set 1 can be configured to a bandwidth used for Machine Type Communication (MTC).

As described above, one radio access technology constituted by multiple different radio parameter sets makes it possible to address a wide range of scalability such as transmission capacity and mobility. For example, the terminal apparatus 20 connecting to the base station apparatus 12 enables large-capacity transmission using a wide bandwidth.

For example, the terminal apparatus 20 connecting to the base station apparatus 10 enables communication not requiring a low latency.

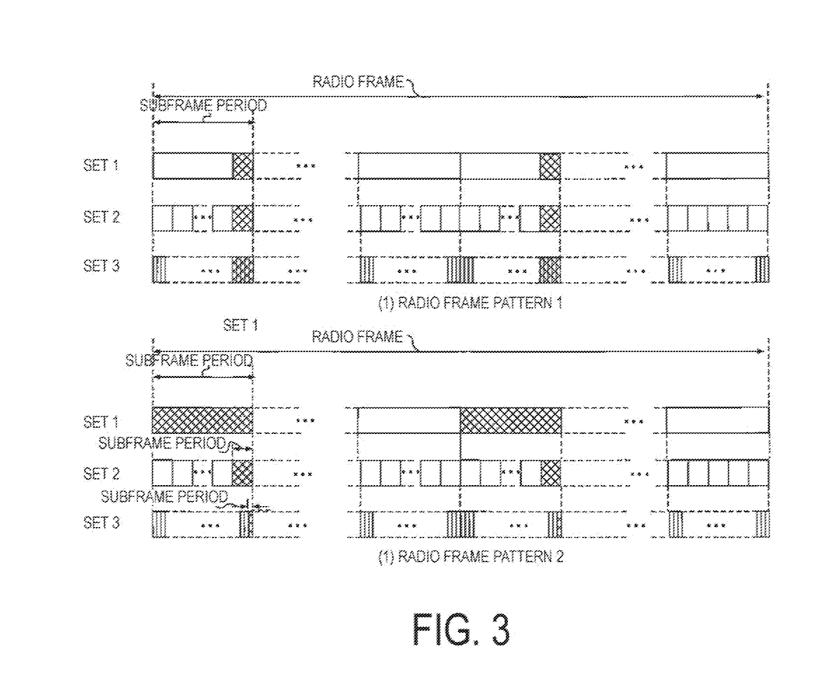

FIG. 3 is a diagram illustrating a configuration example of a radio frame in the radio access technology according to the present embodiment. Radio frame pattern 1 in FIG. 3 is an example in a case that subframe periods are defined to be identical in set 1 to set 3, To be more specific, the number of subframes and the number of OFDM symbols included in one radio frame in set 2 are more than the number of subframes and the number of OFDM symbols included in one radio frame in set 1. The number of subframes and the number of OFDM symbols included in one radio frame in set 3 is more than the number of subframes and the number of OFDM symbols included in one radio frame in each of set 1 and set 2.

Radio frame pattern 2 in FIG. 3 is an example in a case that subframe lengths in set 1 to set 3 are defined to be different from each other. For example, in a case that the OFDM symbol length in set 1 is t1 times the OFDM symbol length in set 2, the subframe length in set 1 can be t1 times the OFDM symbol length in set 2. To be more specific, the number of OFDM symbols included in the subframe length in set 1 can be the same as the number of OFDM symbols included in the subframe length in set 2.

In FIG. 3, each of filled portions represents a period where a synchronization signal is arranged. Radio frame pattern 1 is an example in a case that synchronization signal arrangement lengths are identical in set 1 to set 3, To be more specific, the OFDM symbol lengths that the synchronization signals are arranged in set 1 to set 3 are different from each other. Radio frame pattern 2 is an example in a case that the numbers of OFDM symbols that the synchronization signals are arranged are identical in set 1 to set 3.

One radio frame can include multiple synchronization signals. The base station apparatus can periodically arrange the synchronization signals in one radio frame. Each of the radio frames in FIG. 3 illustrates an example in which the synchronization signal is arranged at the end of the subframe period, but an aspect of the present invention is not limited thereto, and the synchronization signal may be arranged at the head or in the middle of the subframe period.

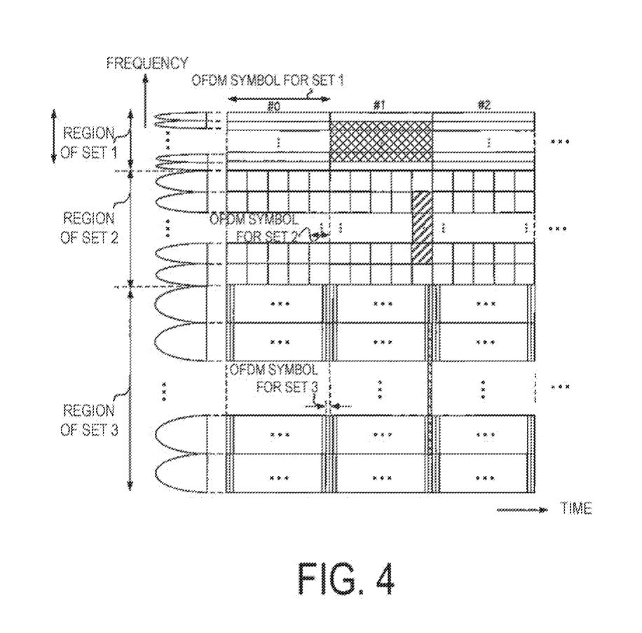

FIG. 4 is a diagram illustrating an arrangement example of each of multiple radio parameters according to the present embodiment. In FIG. 4, a frequency domain is constituted by a region capable of communication in set 1 to a region capable of communication in set 3, the base station apparatus can establish a cell having one system bandwidth constituted by regions capable of communication using multiple radio parameter sets (set 1 to set 3). For example, in FIG. 4, the base station apparatus can frequency-multiplex signals generated using radio parameter sets 1, 2, and 3 for the terminal apparatuses 20-1, 20-2, and 20-3, respectively. The base station apparatus can frequency-multiplex signals generated using radio parameter sets 1, 2, and 3 for the terminal apparatuses 20-1. The region assigned to each of set 1 to set 3 may be fixed or varied. The region of each radio parameter set can be independently configured for each base station apparatus. The regions of the radio parameter sets can be adjusted to be coincided with each other between the adjacent base station apparatuses through cooperation/coordination between the base station apparatuses. The base station apparatus can indicate the region of each radio parameter set to the terminal apparatus. At this time, the terminal apparatus can perform reception processing through the region of each radio parameter set received from the base station apparatus by using the corresponding radio parameter set in each region.

In FIG. 4, the synchronization signal is arranged for each region of each radio parameter set. In FIG. 4, each of cross-hatched portions represents a region where the synchronization signal is arranged for set 1. Each of right-up hatched portions represents a region where the synchronization signal is arranged for set 2. Each of right-up hatched portions represents a region where the synchronization signal is arranged for set 3,

The base station apparatus arranges downlink signals for the terminal apparatus depending on the radio parameter set for which that terminal apparatus establishes synchronization. For example, the terminal apparatus 20-1 uses the synchronization signal arranged in the region of set 1 to establish synchronization. The terminal apparatus 20-2 uses the synchronization signal arranged in the region of set 2 to establish synchronization. The terminal apparatus 20-3 uses the synchronization signal arranged in the region of set 3 to establish synchronization. In this case, the base station apparatus arranges, in one system band, a downlink signal for the terminal apparatus 20-1 in the region of set 1, a downlink signal for the terminal apparatus 20-2 in the region of set 2, and a downlink signal for the terminal apparatus 20-3 in the region of set 3,

The base station apparatus can also arrange the downlink signal for the terminal apparatus 20-1 over the region of set 1 to the region of set 3, At this time, the terminal apparatus 20-1 can use the synchronization signal arranged in at least one region among the synchronization signals arranged in the region of set 1 to the region of set 3 to acquire synchronization in the region of set 1 to the region of set 3, In other words, the base station apparatus can arrange the synchronization signal in at least one region of the region of set 1 to the region of set 3, At this time, the terminal apparatus 20-1 can synchronize by the synchronization signal arranged in at least one region of the region of set 1 to the region of set 3, The base station apparatus can indicate the set in which the synchronization signal is arranged to the terminal apparatus 20-1. At this time, the terminal apparatus 20-1 can use the synchronization signal included in the region of the radio parameter set indicated by the base station apparatus to synchronize.

The base station apparatus can establish a cell in which one system bandwidth is of a region capable of communication using any of set 1 to set 3, A cell constituted by set 1 to set 3 can be associated with the primary cell, the secondary cell, or the primary secondary cell. For example, in a case that the region of set 1 is the primary cell and each of the regions of sets 2 and 3 is the secondary cell, the terminal apparatus can perform carrier aggregation in the region of set 1 to the region of set 3, At this time, the terminal apparatus 20-1 can acquire synchronization in set 1 to set 3 using at least radio parameter set 1.

For example, in a case that the region of set 1 is the primary cell, the region of set 2 is the primary secondary cell, and the region of set 3 is the secondary cell, the terminal apparatus can perform dual connectivity. At this time, the terminal apparatus 20-1 can acquire synchronization in set 1 to set 3 using at least radio parameter sets 1 and 2. This makes it possible to reduce synchronization signal sequence candidates which are searched by the terminal apparatus 20-1 in order to establish synchronization.

Each of set 1 to set 3 can be used for different cells. For example, set 1 can be used for the primary cell/secondary cell/primary secondary cell, set 2 can be used for the secondary cell/primary secondary cell, and set 3 can be used for the secondary cell. At this time, it is sufficient for the terminal apparatus to perform synchronization processing or cell search using set 1 in the primary cell, improving efficiency of synchronization/cell search. The base station apparatus can indicate the radio parameter sets for the Secondary Cell/Primary Secondary Cell to the terminal apparatus. At this time, the terminal apparatus can use the radio parameter set indicated by the base station apparatus to perform the synchronization/cell search. The base station apparatus can map the synchronization signal to a part of set 1 to set 3,

As described above, the synchronization signal is arranged in the region of each radio parameter set. This allows the terminal apparatus to efficiently perform the cell search even in the radio access technology that the base station apparatus scalably arranges the terminal apparatus for the region of each radio parameter set.

In a case that the base station apparatus establishes synchronization with the terminal apparatus using a certain radio parameter set, the base station apparatus can notify of a parameter for synchronization in another radio parameter. For example, in a case that the terminal apparatus uses the synchronization signal in the region of set 1 to establish synchronization, the base station apparatus can use the downlink signal for the region of set 1 to notify the terminal apparatus of parameters for the synchronization signals in the region of set 2/set 3. The parameter for the synchronization signal include some or all of a root of the synchronization signal sequence, a cyclic shift amount given to the synchronization signal sequence, and a cell ID associated with the synchronization signal sequence.

For example, in the case that the region of set 1 is the primary cell, the region of set 2 is the primary secondary cell, and the region of set 3 is the secondary cell, the terminal apparatus can perform dual connectivity. At this time, in the case that the terminal apparatus uses the synchronization signal in the region of set 1 to establish synchronization, the base station apparatus can use the downlink signal for set 1 to notify the terminal apparatus of the parameter for the synchronization signal in the region of set 2. This makes it possible to reduce synchronization signal sequence candidates which are searched by the terminal apparatus 20-1 in order to establish synchronization.

As described above, in a case that the terminal apparatus establishes synchronization using any of the multiple radio parameter sets, the base station apparatus uses the radio parameter set that the synchronization is established to assist information on the synchronization signal of another radio parameter set with respect to the terminal apparatus. This can reduce the number of synchronization signal sequence candidates used by the terminal apparatus for the cell search, enabling load reduction and cell search time shortening.

The terminal apparatus supporting only the radio parameter set of set 1 uses the synchronization signal sequence of the region of set 1 to establish synchronization. To be more specific, the terminal apparatus uses the synchronization signal sequence candidate of set 1 to perform synchronization detection processing. On the other hand, the terminal apparatus supporting the radio parameter sets of set 1 to set 3 uses the synchronization signal sequences of the region of set 1 to the region of set 3 to establish synchronization. To be more specific, the terminal apparatus uses the synchronization signal sequence candidates of set 1 to set 3 to perform the synchronization detection (cell search).

In a case that the terminal apparatus uses any of the multiple radio parameter sets to establish synchronization, the radio parameter set that the synchronization is established is used to transmit capability of the terminal apparatus. The base station apparatus transmits information on the synchronization signal sequence of each radio parameter set to the terminal apparatus depending on the capability.

For example, in a case that the terminal apparatus supporting the radio parameters of set 1 to set 3 establishes synchronization using set 1, the base station apparatus notifies the terminal apparatus of information on the synchronization signal sequences of set 2 and set 3 using the downlink signal for set 1.

As described above, even in the case that there are mixedly the terminal apparatuses different in the supporting radio parameter set, each terminal apparatus can efficiently establish synchronization.

FIG. 4 illustrates the case that the numbers of OFDM symbols that the synchronization signals are arranged are identical in the regions of set 1 to set 3, but the embodiment is not limited to this case. The arrangement may be made also such that time lengths in which the synchronization signals are arranged are identical in the regions of set 1 to set 3. For example, the synchronization signals of set 2 and set 3 can be arranged in a time length the same as the OFDM symbol length that the synchronization signal of set 1 is arranged, in the regions of set 1 to set 3.

In FIG. 1, multiple uplink physical channels are arranged for uplink radio communication from the terminal apparatus 20 to the base station apparatuses 10 to 12. The uplink physical channels are used for transmission of information output from higher layers.

Arranged in the uplink physical channel is a physical channel (uplink control channel) used for transmission of Uplink Control Information (UCI). This physical uplink data channel can include information indicating the radio parameter set (e.g., radio parameter sets 1 to 3 in FIG. 2) which the terminal apparatus 20 can use. This allows the terminal apparatus 20 to dynamically notify the radio parameter set which the terminal apparatus 20 can use/the terminal apparatus 20 desires to use. This uplink physical channel can include a function of a Physical Uplink Control Channel (PUCCH) in LTE. The Uplink Control Information can include a positive acknowledgement (ACK) or a negative acknowledgement (NACK) (ACK/NACK) for downlink data (a downlink transport block, a Downlink-Shared Channel (DL-SCH)). The ACK/NACK for the downlink data is also referred to as HARQ-ACK or HARQ feedback.

The Uplink Control Information includes Channel State Information (CSI) for the downlink. The Uplink Control Information includes a Scheduling Request (SR) used to request a resource of an Uplink-Shared Channel (UL-SCH) resource. The Channel State Information refers to a Rank Indicator (RI) specifying a suited spatial multiplexing number, a Precoding Matrix Indicator (PMI) specifying a suited precoder, a Channel Quality Indicator (CQI) specifying a suited transmission rate, and the like.

The Channel Quality Indicator (hereinafter, referred to as a CQI value) can be a suited modulation scheme (e.g., QPSK, 16QAM, 64QAM, 256QAM, or the like) and a suited coding rate in a predetermined band (details of which will be described later). The CQI value can be an index (CQI Index) determined by the above change scheme, coding rate, and the like. The CQI value can take a value determined beforehand in the system.

The Rank Indicator and the Precoding Quality Indicator can take the values determined beforehand in the system. Each of the Rank Indicator, the Precoding Matrix Indicator, and the like can be an index determined by the number of spatial multiplexing, Precoding Matrix information, or the like. Note that values of the Rank Indicator, Precoding Matrix Indicator, and Channel Quality Indicator CQI are collectively referred to as CSI values.

Arranged in the uplink physical channel is a physical channel (uplink data channel) used for transmission of uplink data (uplink transport block, UL-SCH). This physical uplink data channel can include a function of a Physical Uplink Shared Channel (PUSCH) in LTE. Furthermore, this physical uplink data channel may be used for transmission of the ACK/NACK and/or the Channel State Information along with the uplink data. In addition, this physical uplink data channel may be used for transmission of the Uplink Control Information only.

In addition, this physical uplink data channel may be used for transmission of an RRC message. The RRC message is information/signal that is processed in a Radio Resource Control (RRC) layer. This physical uplink data channel can include information indicating the radio parameter set (e.g., radio parameter sets 1 to 3 in FIG. 2) which the terminal apparatus 20 can use. This downlink data channel can include information indicating this radio parameter set in the RRC message. This allows the terminal apparatus 20 to semi-statically/statically notify of the radio parameter set which the terminal apparatus 20 can use/the terminal apparatus 20 desires to use. Further, this physical uplink data channel is used for transmission of an MAC Control Element (CE). Here, MAC CE is a signal/information that is processed (transmitted) in a Medium Access Control (MAC) layer.

Arranged in the uplink physical channel is a physical channel (random access channel) used for transmission of a random access preamble. This physical uplink data channel can include a function of a Physical Random Access Channel (PRACH) in LTE.

In the uplink radio communication, an UpLink Reference Signal (UL RS) is used as an uplink physical signal. The uplink physical signal is not used for transmission of information output from higher layers, but is used by the physical layer. The Uplink Reference Signal includes a Demodulation Reference Signal (DMRS) and a Sounding Reference Signal (SRS).

The DMRS relates to transmission on the physical channel used for transmission of the uplink data or the physical channel used for transmission of the Uplink Control Information. For example, the base station apparatuses 10 to 12 use the DMRS to perform channel compensation of the physical channel used for transmission of the uplink data or the physical channel used for transmission of the Uplink Control Information. The SRS does not relate to transmission on the physical channel used for transmission of the uplink data or the physical channel used for transmission of the Uplink Control Information. For example, the base station apparatuses 10 to 12 use the SRS to measure an uplink channel state.

In FIG. 1, multiple downlink physical channels are arranged for downlink radio communication from the base station apparatuses 10 to 12 to the terminal apparatus 20. The downlink physical channels are used for transmission of information output from higher layers.

Arranged in the downlink physical channel is a physical channel (broadcast channel) used for broadcasting a Master Information Block (MIB, a Broadcast Channel (BCH)) that is shared by the terminal apparatuses. This downlink physical channel can include a function of a Physical Broadcast Channel (PBCH) in LTE.

Arranged in the downlink physical channel (control format indicator channel) is a physical channel which transmits information indicating a region used for transmission of a downlink control channel (e.g., the number of OFDM symbols). This downlink physical channel can include a function of a Physical Control Format Indicator Channel (PCFICH) in LTE.

Arranged in the downlink physical channel is a physical channel (HARQ indicator channel) used for transmission of ACK/NACK with respect to the uplink data (transport block, codeword) received by the base station apparatuses 10 to 12. This downlink physical channel can include a function of a Physical Hybrid automatic repeat request Indicator Channel (PHICH) in LTE. In other words, this downlink physical channel is used for transmission of a HARQ indicator (HARQ feedback) indicating ACK/NACK with respect to the uplink data. Note that ACK/NACK is also called HARQ-ACK. The terminal apparatus 20 reports ACK/NACK having been received to a higher layer. ACK/NACK refers to ACK indicating a successful reception, NACK indicating an unsuccessful reception, and DTX indicating that no corresponding data is present. In a case that the HARQ indicator channel for the uplink data is not present, the terminal apparatus 2A reports ACK to a higher layer.

Arranged in the downlink physical channel is a physical channel (downlink control channel) used for transmission of Downlink Control Information (DCI). This downlink physical channel can include a function of a Physical Downlink Control Channel (PDCCH)/Enhanced Physical Downlink Control Channel (EPDCCH) in LTE.

The downlink control channel is used for transmission of Downlink Control Information (DCI). Here, multiple DCI formats are defined for transmission of the Downlink Control Information. In other words, a field for the Downlink Control Information is defined in a DCI format and is mapped to information bits.

For example, as a DCI format for the downlink, a DCI format to be used for the scheduling of one downlink data channel in one cell (transmission of a single downlink transport block) is defined. This DCI format can include a function of DCI format 1A in LTE.

For example, the DCI format for the downlink includes Downlink Control Information such as information of downlink data channel resource allocation, information of a Modulation and Coding Scheme (MCS) for the downlink data channel, and a TPC command for the uplink control channel. Here, the DCI format for the downlink is also referred to as downlink grant (or downlink assignment).

For example, as a DCI format for the uplink, a DCI format to be used for the scheduling of one uplink data channel in one cell (transmission of a single uplink transport block) is defined. This DCI format can include a function of DCI format 0 in LTE.

For example, the DCI format for the uplink includes Uplink Control Information such as information of uplink data channel resource allocation, information of a MCS for the uplink data channel, and a TPC command for the uplink data channel. The DCI format for the uplink is also referred to as uplink grant (or uplink assignment).

Further, the DCI format for the uplink can be used to request the downlink Channel State Information (CSI) (CSI request), which is also called reception quality information.

The DCI format for the uplink can be used for a configuration indicating an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (Periodic CSI). The CSI feedback report can be used for a mode configuration (CSI report mode) to periodically report the Channel State Information.

For example, the CSI feedback report can be used for a configuration indicating an uplink resource to report aperiodic Channel State Information (Aperiodic CSI). The CSI feedback report can be used for a mode configuration (CSI report mode) to aperiodically report the Channel State Information. The base station apparatus can configure any one of the periodic CSI feedback report and the aperiodic CSI feedback report. In addition, the base station apparatus can configure both the periodic CSI feedback report and the aperiodic CSI feedback report.

The DCI format for the uplink can be used for a configuration indicating a type of the CSI feedback report that is fed back to the base station apparatus by the terminal apparatus. The type of the CSI feedback report includes wideband CSI (e.g., Wideband CQI), narrowband CSI (e.g., Subband CQI), and the like.

In a case that a downlink data channel resource is scheduled in accordance with the downlink assignment, the terminal apparatus receives downlink data on the scheduled downlink data channel. In a case that a PUSCH resource is scheduled in accordance with the uplink grant, the terminal apparatus transmits uplink data and/or Uplink Control Information on the scheduled PUSCH.

Each DCI format described above can include information indicating the radio parameter set (e.g., radio parameter sets 1 to 3 in FIG. 2) which the terminal apparatus 20 can use. This allows the terminal apparatus 20 to dynamically recognize the radio parameter set which the terminal apparatus 20 can use.

Arranged in the downlink physical channel is a physical channel (downlink data channel) used for transmission of downlink data (downlink transport block, DL-SCH). This downlink physical channel can include a function of a Physical Downlink Shared Channel (PDSCH) in LTE. The downlink data channel is used for transmission of a system information block type 1 message. The system information block type 1 message is cell-specific information.

The downlink data channel is used for transmission of a system information message. The system information message includes a system information block X other than the system information block type 1. The system information message is cell-specific information.

The downlink data channel is used for transmission of an RRC message. Here, the RRC message transmitted from the base station apparatus may be shared by multiple terminal apparatuses in a cell. Further, the RRC message transmitted from each of the base station apparatuses 10 to 12 may be a dedicated message (also referred to as dedicated signaling) to a certain terminal apparatus 20. In other words, user-equipment-specific information (unique to user equipment) is transmitted using a message dedicated to the certain terminal apparatus. The downlink data channel can include information indicating the radio parameter set (e.g., radio parameter sets 1 to 3 in FIG. 2) which the terminal apparatus 20 can use. This downlink data channel can include information indicating this radio parameter set in the RRC message. This allows the terminal apparatus 20 to semi-statically/statically recognize the radio parameter set which the terminal apparatus 20 can use.

The downlink data channel is used for transmission of a MAC CE. Here, the RRC message and/or MAC CE is also referred to as higher layer signaling.

The downlink data channel can be used to request downlink Channel State Information. The downlink data channel can be used for transmission of an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (Periodic CSI). The CSI feedback report can be used for a mode configuration (CSI report mode) to periodically report the Channel State Information.

The type of the downlink CSI feedback report includes wideband CSI (e.g., Wideband CSI) and narrowband CSI (e.g., Subband CSI). The wideband CSI calculates one piece of Channel State Information for the system band of a cell. The narrowband CSI divides the system band into predetermined units, and calculates one piece of Channel State Information for each division.

In the downlink radio communication, a Downlink Reference Signal (DL RS) and a Synchronization signal (SS) are used as downlink physical signals. The downlink physical signals are not used for transmission of information output from the higher layers, but are used by the physical layer. The Downlink Reference Signal is used for the terminal apparatus to perform the channel compensation on the downlink physical channel. For example, the Downlink Reference Signal is used for the terminal apparatus to calculate the downlink Channel State Information.

Here, the Downlink Reference Signals include a UE-specific Reference Signal (URS: terminal-specific reference signal, terminal apparatus specific reference signal), a Demodulation Reference Signal (DMRS), and a Chanel State Information-Reference Signal (CSI-RS) which are associated with the downlink data channel. The Downlink Reference Signals can include a Cell-specific Reference Signal (CRS).

The DMRS relates to transmission on the physical channel used for transmission of the downlink data or the physical channel used for transmission of the Downlink Control Information. For example, the terminal apparatus 20 uses the DMRS to perform channel compensation of the physical channel used for transmission of the downlink data or the physical channel used for transmission of the Downlink Control Information.

The CSI-RS does not relate to transmission on the physical channel used for transmission of the downlink data or the physical channel used for transmission of the Downlink Control Information. For example, the terminal apparatus 20 uses the CSI-RS to measure downlink channel states between the terminal and the base station apparatuses 10 to 12. With zero output, the base station apparatuses 10 to 12 can also transmit the CSI-RS. This allows the terminal apparatus 20 to perform interference measurement in a resource to which this CSI-RS corresponds.

The CRS is transmitted in the entire band of a subframe, and can be used to demodulate the broadcast channel/downlink control channel/HARQ indicator channel/control format indicator channel/downlink data channel. The URS associated with the downlink data channel is transmitted in a subframe and a band that are used for transmission of the downlink data channel which the URS is associated with, and is used to demodulate the downlink data channel which the URS is associated with.

The synchronization signal is used for the terminal apparatus 20 to search for the cells constituted by the base station apparatuses 10 to 12 in order to connect to the base station apparatuses 10 to 12. The synchronization signal is used in the cell search procedure to synchronize in the time domain in the downlink such as the radio frame synchronization and the symbol synchronization. The synchronization signal is used in the cell search procedure to synchronize in the frequency domain in the downlink. Further, the synchronization signal is used in the cell search procedure for the terminal apparatus to detect a cell ID.

The downlink physical channels and the downlink physical signals are also collectively referred to as a downlink signal. The uplink physical channels and the uplink physical signals are also collectively referred to as an uplink signal. The downlink physical channels and the uplink physical channels are also collectively referred to as physical channels. The downlink physical signals and the uplink physical signals are also collectively referred to as physical signals.

The BCH, UL-SCH, and DL-SCH are transport channels. The channels used in the MAC layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword and subject to coding processing or the like on a codeword basis.

The downlink signal and the uplink signal are arranged in a resource element. The resource element refers to a minimum unit for arranging a signal including one subcarrier and one OFDM symbol. A resource block refers to a unit of resources for collecting multiple resource elements, and is a minimum unit of resources allocated for each terminal apparatus. For example, the resource block may be a resource including 12 subcarriers and seven OFDM symbols.

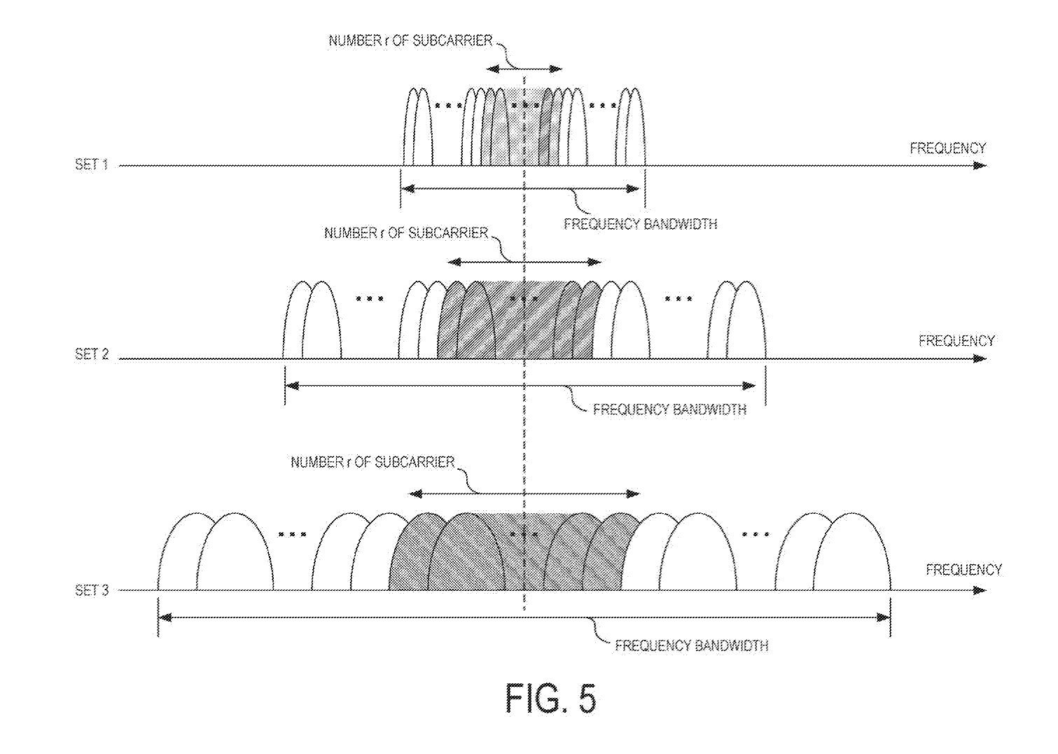

FIG. 5 is a diagram illustrating an example of an OFDM subcarrier configuration according to the present embodiment. Set 1 to set 3 in FIG. 5 correspond to those in FIG. 2 to FIG. 4. In FIG. 5, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. In FIG. 5, each of the subcarriers of white solid portions is a subcarrier where the downlink signal other than the synchronization signal is arranged. In FIG. 5, the subcarrier where the synchronization signal is arranged at a center of the frequency bandwidth available in each set. In FIG. 5, the number of subcarriers that synchronization signals are arranged is r that is common to set 1 to set 3, the number r of subcarriers can be configured to be the number of subcarriers constituting one resource block. The number r of subcarriers can be configured to the number of subcarriers constituting a prescribed number of resource blocks. For example, in a case that the number of subcarriers constituting one resource block is 12, and the synchronization signals are arranged over 6 resource blocks, the synchronization signals are arranged in 72 subcarriers. In a case that the terminal apparatus 20 uses a bandpass filter in order to acquire the synchronization signal, the synchronization signal is arranged taking a guard band into consideration. For example, the synchronization signals are arranged in 63 subcarriers of 72 subcarriers described above.

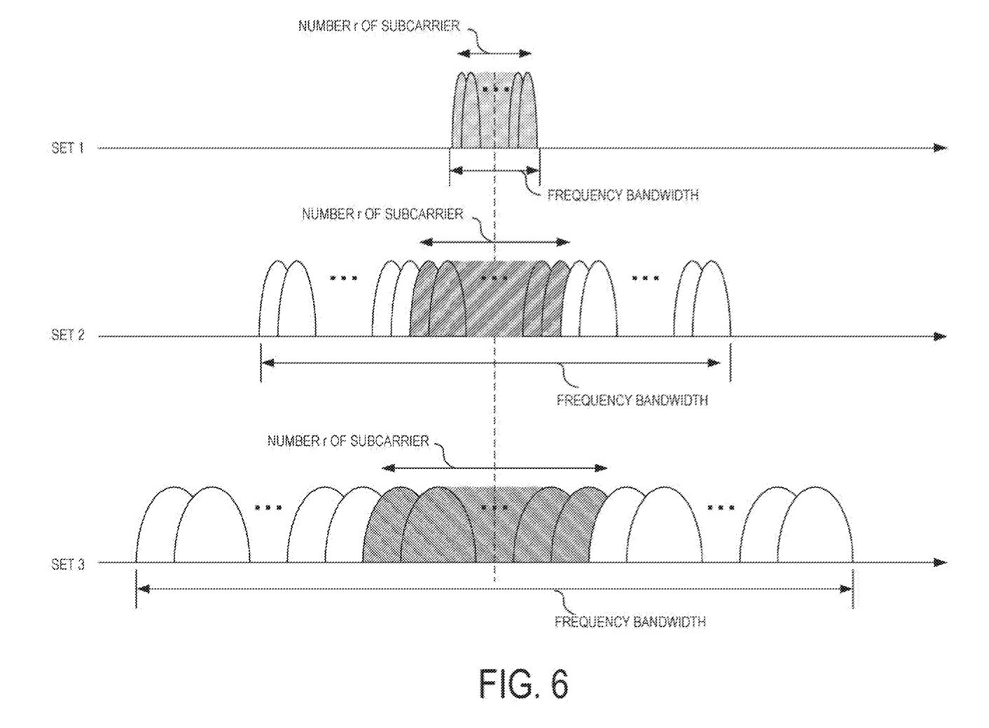

FIG. 6 is a diagram illustrating another example of the OFDM subcarrier configuration according to the present embodiment. Set 1 to set 3 in FIG. 6 correspond to those in FIG. 2 to FIG. 4. In FIG. 6, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. In FIG. 6, the subcarrier where the synchronization signal is arranged is arranged at a center of the frequency bandwidth available in each set. In FIG. 6, the synchronization signals are arranged in the subcarriers constituting the frequency bandwidth available in set 1. In set 1, the number of subcarriers that the synchronization signals are arranged is r. The number of subcarriers that the synchronization signals are arranged is r that is common to set 1 to set 3. The number r of subcarriers can be configured to be the number of subcarriers constituting one resource block. The number r of subcarriers can be configured to the number of subcarriers constituting a prescribed number of resource blocks.

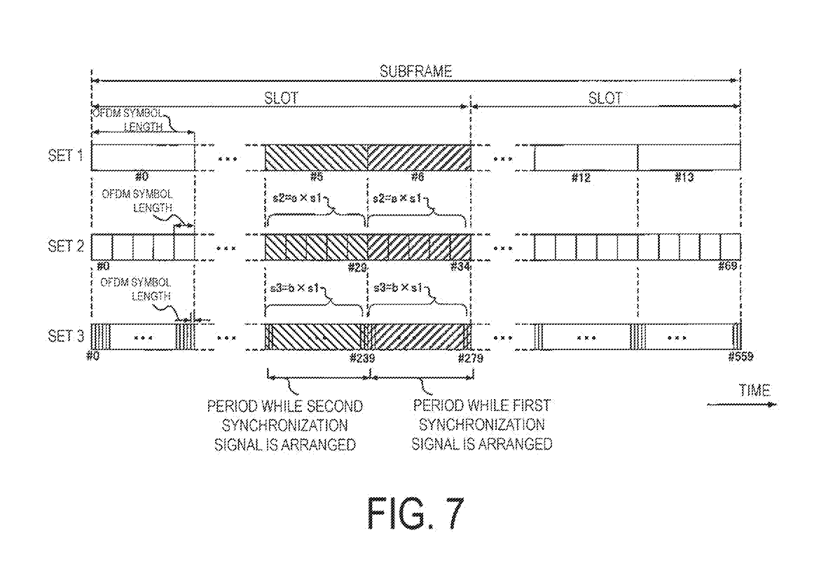

FIG. 7 is a diagram illustrating a configuration example of the OFDM symbols per a subframe in the radio access technology according to the present embodiment. Set 1 to set 3 in FIG. 7 correspond to those in FIG. 2 to FIG. 6. FIG. 7 illustrates an example of a case that the subframe lengths are identical in set 1 to set 3. Set 1 is an example constituted of 14 OFDM symbols per one subframe. Each subframe is constituted by two slots. Set 1 is constituted of seven OFDM symbols per one slot. Set 2 is an example constituted of 70 OFDM symbols per one subframe. Set 2 is constituted of 35 OFDM symbols per one slot. Set 3 is an example constituted of 560 OFDM symbols per one subframe. Set 3 is constituted of 280 OFDM symbols per one slot.

In FIG. 7, the sampling frequencies in set 2 and set 3 are five times and 40 times the sampling frequency in set 1, respectively. The OFDM symbol lengths in set 2 and set 3 are one fifth and one fortieth of the OFDM symbol length in set 1, respectively.

FIG. 7 illustrates the subframe (subframe #0 or #5 in FIG. 5) in which the synchronization signal is arranged in the radio frame. In FIG. 7, a first synchronization signal is arranged in the OFDM symbol of a right-up hatched portion. In FIG. 7, a second synchronization signal is arranged in the OFDM symbol of a left-up hatched portion. In FIG. 7, the OFDM symbol of a white solid portion is an OFDM symbol that the synchronization signal is not arranged. In set 1, set 2, and set 3, lengths of times in which the synchronization signals are arranged is identical. In set 1, set 2, and set 3, the number of OFDM symbols that the synchronization signals are arranged are different from each other. In FIG. 7, the number of OFDM symbols for the synchronization signals arranged in set 2 is five times the number of OFDM symbols for the synchronization signal arranged in set 1. The number of OFDM symbols for the synchronization signals arranged in set 3 is 40 times the number of OFDM symbols for the synchronization signal arranged in set 1. FIG. 7 illustrates an example indicating that the OFDM symbol that the synchronization signal is arranged is configured according to a relationship with the sampling frequency and the OFDM symbol length, and an aspect of the present invention is not limited to such parameter values.

The first synchronization signal and the second synchronization signal are arranged in some of the OFDM symbols constituting the subframe. In FIG. 7, an example is illustrated in which the first synchronization signals and the second synchronization signals are arranged in some of the OFDM symbols in the first half slot constituting one subframe. The first synchronization signal can be used to acquire the symbol synchronization. The cell ID for connection by the terminal apparatus is determined in accordance with a combination of a second cell ID specified by the first synchronization signal and a first cell ID specified by the second synchronization signal (also referred to as a cell ID group). To be more specific, the first synchronization signal can be used to detect the second cell ID. The second synchronization signal can be used to acquire the symbol synchronization/frame synchronization. The second synchronization signal can be used to detect the first cell ID.

Sequence lengths used for the first synchronization signal and the second synchronization signal are determined according to the number of subcarriers and the number of OFDM symbols that the respective synchronization signals are arranged. Here, assuming that the number of OFDM symbols that the synchronization signals are arranged in set 1, set 2, and set 3 are s1, s2, and s3, respectively, it is satisfied that s2=a*s1 and s3=b*s2. For example, a is a sampling frequency ratio between set 1 and set 2, and b is a sampling frequency ratio between set 1 and set 3. In FIG. 7, s1=1, s2=5, s3=40, a=5, and b=40. The number of subcarriers that the synchronization signals are arranged in set 1 to set 3 is r (in FIG. 5 and FIG. 6).

A description is given of a case that a Zadoff-Chu sequence is used as an example of the first synchronization signal sequence. A first synchronization signal sequence d1(n) is expressed by an equation below. This equation is an example of a case that r=62, where r is the number of subcarriers that the synchronization signals are arranged.

$$\begin{matrix}[ Equation 1 ] & \\ {d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} & ( 1 )\end{matrix}$$

Here, an index u is a value to be a root of the Zadoff-Chu sequence. The base station apparatus and the terminal apparatus can hold a table indicating association between the index u and the root of the Zadoff-Chu sequence, in advance. The first synchronization signal sequence given by the table indicating the association is also called a first synchronization sequence candidate. Here, the index u is associated with a cell ID specified by the first synchronization signal sequence. The number of cell IDs detected by the first synchronization signal can be increased by increasing the number of indices u. For example, in a case that the number of cell IDs specified by the first synchronization signal sequence is x, the number of indices u is x.

In set 1, the first synchronization signal sequence d1(n) generated with a certain index u in the table of the index u is mapped to the OFDM symbols and subcarriers that the first synchronization signals are arranged. A sequence length of the first synchronization signal sequence d1(n) can be the same as the number of resource elements that the synchronization signal is arranged in one slot in set 1. The sequence length of the first synchronization signal sequence d1(n) can be also the same as the number of resource elements that the synchronization signal is arranged in one subframe in set 1. Assuming that the number of resource elements to which the synchronization signals are mapped in set 1 is r*s1, the sequence length of the first synchronization signal sequence d1(n) is r*s1. A sequence length of the first synchronization signal sequence d1(n) arranged in each of set 2 and set 3 is also r*s1. FIG. 7 illustrates an example of a case that s1=1, where s1 is the number of OFDM symbols that the synchronization signals are arranged in set 1. To be more specific, in set 1 in FIG. 7, the first synchronization signal sequence d(n) of a sequence length r is mapped to the number r of subcarriers constituting one OFDM symbol (OFDM symbol #6).

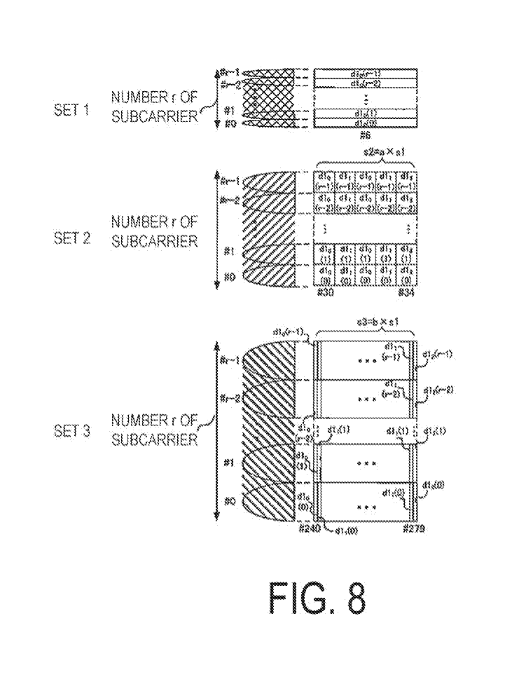

FIG. 8 is a diagram illustrating an arrangement example of the first synchronization signal according to the present embodiment. In each of set 1 to set 3 in FIG. 8, FIG. 8 corresponding to FIG. 2 to FIG. 7, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. The number r of subcarriers in set 1 in FIG. 8 corresponds to the subcarriers that the synchronization signals are arranged in the region of set 1 in FIG. 4. Similarly, the number r of subcarriers in set 2 in FIG. 8 corresponds to the subcarriers that the synchronization signals are arranged in the region of set 2 in FIG. 4. The number r of subcarriers in set 3 in FIG. 8 corresponds to the subcarriers that the synchronization signals are arranged in the region of set 3 in FIG. 4. FIG. 8 illustrates an example of a case that the synchronization signals are arranged in the identical time length in set 1 to set 3.

In set 1, the first synchronization signal sequence d1(n)_u(n) generated with a certain index u in the table of the index u is mapped to the frequency domain in the OFDM symbol #6 that the first synchronization signal is arranged. Set 1 in FIG. 8 is an example of a case that a synchronization signal sequence d1_0(n) with index u=0 is mapped. The terminal apparatus 20 uses the first synchronization signal arranged in the OFDM #6 to detect the cell ID and acquire the symbol synchronization. Here, assuming that the number of indices u of the first synchronization signal sequence d1(n) is x1, the number of cell IDs (N_ID̂(2)) specified by the first synchronization signal is x1*s1 in set 1. FIG. 8 illustrates an example of a case of s1=1, the number of cell IDs specified by the first synchronization signal is x1 in set 1.

In set 2, the multiple first synchronization signal sequences d1(n) generated with the index u are mapped to the OFDM symbols and subcarriers that the first synchronization signals are arranged. In set 2, the first synchronization signal sequence d1(n) is mapped to the frequency domain for each OFDM symbol. In set 2, assuming that the number of resource elements to which the first synchronization signals are mapped is r*s2, it is satisfied that r*s2=r*a*s1. The first synchronization signal sequences d1(n) mapped to the frequency domain are aligned in the time domain in “a” rows, which means that the number of rows is “a”. The synchronization signal of set 2 is generated using the first synchronization signal sequence d1 in set 1 as a base synchronization signal sequence.

In set 2 in FIG. 8, each of “a” first synchronization signal sequences d1(n) aligned in the time domain is selected from any of x1 indices u (x1=3 in FIG. 1). In FIG. 8, the first synchronization signals are mapped to five OFDM symbols of OFDM symbol numbers #30 to #34. The index u of the first synchronization signal sequence d1 (n) mapped to the OFDM symbol number #30 is selected from any of x1 indices. FIG. 8 illustrates an example of a case that the first synchronization signal sequence d1_0(n) with u=0 is mapped to the OFDM symbol number #30. The indices u of the first synchronization signal sequences d1(n) mapped to OFDM symbol numbers #31 to #34 are similarly selected from any of x1 indices. FIG. 8 illustrates an example in which the first synchronization signal sequence d1_1(n) with u=1 is mapped to the OFDM symbol number #31, the first synchronization signal sequence d1_0(n) with u=0 is mapped to the OFDM symbol number #32, the first synchronization signal sequence d1_1(n) with u=1 is mapped to the OFDM symbol number #33, and the first synchronization signal sequence d1_2(n) with u=2 is mapped to the OFDM symbol number #34.

The terminal apparatus 20 uses a series of the first synchronization signal sequences arranged in the OFDM #30 to #34 (a block of multiple first synchronization signal sequences d1(n)) to detect the cell ID and acquire the symbol synchronization in set 2 in FIG. 8. In set 2, the cell ID (N_ID̂(2)) specified by the first synchronization signal is determined in accordance with a combination of the first synchronization signal sequences d1(n). In set 2 in FIG. 8, the number of cell IDs specified by the first synchronization signal is a*x1.

The cell ID specified by the first synchronization signal sequence d1(n) arranged in each of the OFDM #30 to #34 may be a sub-cell ID such that the cell ID in set 2 can be specified in accordance with a combination of the sub-cell IDs.

In set 3, the multiple first synchronization signal sequences d1(n) generated with the index u are mapped to the OFDM symbols and subcarriers that the first synchronization signals are arranged. In set 3, the first synchronization signal sequence d1(n) is mapped to the frequency domain for each OFDM symbol. In set 3, assuming that the number of resource elements to which the first synchronization signals are mapped is r*s3, it is satisfied that r*s3=r*b*s1. The first synchronization signal sequences d1(n) mapped to the frequency domain are aligned in the time domain in “b” rows which means that the number of rows is “b”. The synchronization signal of set 3 is generated using the first synchronization signal sequence d1 in set 1 as a basic synchronization signal sequence.

In set 3 in FIG. 8, each of “b” first synchronization signal sequences d1(n) aligned in the time domain is selected from any of x1 indices u. In FIG. 8, the synchronization signals are mapped to 40 OFDM symbols of OFDM symbol numbers #240 to #279. The index u of the first synchronization signal sequence d1(n) mapped to the OFDM symbol number #240 is selected from any of x1 indices. FIG. 8 illustrates an example of a case that the first synchronization signal sequence d1_0(n) with u=0 is mapped to the OFDM symbol number #240. The indices u of the first synchronization signal sequences d1(n) mapped to OFDM symbol numbers #241 to #279 are similarly selected from any of x1 indices.

The terminal apparatus 20 uses a series of synchronization signal sequences arranged in the OFDM #240 to #279 (multiple first synchronization signal sequences d1(n)) to detect the cell ID and acquire the symbol synchronization in set 3. In set 3, the cell ID (N_ID̂(2)) specified by the first synchronization signal is determined in accordance with a combination of the first synchronization signal sequences d1(n). In set 3 in FIG. 8, the number of cell IDs specified by the first synchronization signal is b*x1.

The cell ID specified by the first synchronization signal sequence d1(n) arranged in each of the OFDM #240 to #279 may be a sub-cell ID such that the cell ID in set 3 can be specified in accordance with a combination of the sub-cell IDs.

In the case that the terminal apparatus establishes synchronization in set 1, the base station apparatus can transmit the root of the first synchronization signal sequence d1(n) arranged in each of the OFDM #30 to #34 in set 2 on the region of set 1. The base station apparatus can notify the cell ID specified by a series of the first synchronization signal sequences d1 arranged in the OFDM #30 to #34 in set 2 on the region of set 1.

Similarly, in the case that the terminal apparatus establishes synchronization in set 1, the base station apparatus can transmit the root of the first synchronization signal sequence d1(n) arranged in each of the OFDM #240 to #279 in set 3 on the region of set 1. The base station apparatus can notify the cell ID specified by a series of the first synchronization signal sequences d1 arranged in the OFDM #240 to #279 in set 2 on the region of set 1. This causes the base station apparatus to explicitly search for a sequence only for the second synchronization signal sequence in the cell search in sets 2 and 3.

In the case that the terminal apparatus establishes synchronization in set 1, the base station apparatus notifies information on the first and second synchronization signal sequences in sets 2 and 3, which allows the terminal apparatus to implicitly search for both sequences. This makes it possible to reduce the synchronization signal sequence candidates which are used to establish synchronization by the terminal apparatus, reducing load in establishing synchronization by the terminal apparatus.

As described above, in the present embodiment, the base synchronization signal sequences d1(n) are combined depending on the sampling frequency/OFDM symbol length of each radio parameter set. This can prevent synchronization acquisition accuracy from deteriorating due to a sampling error even in a case of high sampling frequency. Each of the base synchronization signal sequences d1(n) combined is configured with a root. In each radio parameter set, the cell ID is specified by a series of synchronization signals constituted by the combination of the base synchronization signal sequences. This increases the number of cell IDs specified by the first synchronization signal in set 2 and set 3, which can prevent the accuracy in the synchronization signal acquisition and cell ID detection from deteriorating due to interference from another cell even in a case of dense cell arrangement or rough cell arrangement. The present embodiment uses the Zadoff-Chu sequence as the first synchronization signal sequence, but is not limited thereto, and may use any sequence so long as the terminal apparatus can acquire the symbol synchronization and detect the cell ID by means of the sequence.

A description is given of a case that an M-sequence is used as an example of the second synchronization signal sequence. The second synchronization signal sequence is generated by coupling two short sequences. Multiple second synchronization signal sequences can be arranged in one radio frame. In this case, the second synchronization signals arranged in the subframes are different in their sequences. A second synchronization signal sequence d2 in set 1 in FIG. 7 can be expressed by equations below. These equations are an example of a case that the second synchronization signal sequence is arranged in the subframe #0 and the subframe #5, and r=62, r being the number of subcarriers that the synchronization signals are arranged.

$$\begin{matrix}[ Equation 2 ] & \\ d ( 2 n ) = \{ \begin{matrix}{s}_{0}^{( {m}_{0} )} ( n ) {c}_{0} ( n ) & in subframe 0 \\ {s}_{1}^{( {m}_{1} )} ( n ) {c}_{0} ( n ) & in subframe 5\end{matrix} \\ d ( 2 n + 1 ) = \{ \begin{matrix}{s}_{1}^{( {m}_{1} )} ( n ) {c}_{1} ( n ) {z}_{1}^{( {m}_{0} )} ( n ) & in subframe 0 \\ {s}_{0}^{( {m}_{0} )} ( n ) {c}_{1} ( n ) {z}_{1}^{( {m}_{1} )} ( n ) & in subframe 5\end{matrix} & ( 2 )\end{matrix}$$

where, 0<n<30. m0 and m1 are determined by the following equations. C0, C1, and Z1 are scramble sequences.

$$\begin{matrix}[ Equation 3 ] & \\ {m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID}^{( 1 )} + q ( q + 1 ) / 2 , q = ⌊ \frac{{N}_{ID}^{( 1 )} + {q}^{′} ( {q}^{′} + 1 ) / 2}{30} ⌋ , \\ {q}^{′} = ⌊ {N}_{ID}^{( 1 )} / 30 ⌋ & ( 3 )\end{matrix}$$

Indices m0 and m1 are associated with N_ID̂(1). To be more specific, N_ID̂(1) is specified in accordance with a combination of m0 and m1. A correspondence between the combination of m0 and m1 and N_ID̂(1) can be defined in advance in the communication system such that the base station apparatus and the terminal apparatus already know the correspondence. N_ID̂(1) is the cell ID specified by the second synchronization signal.

In Equation 2, two short sequences S0 and S1 are generated by cyclically shifting an M-sequence S˜. The short sequences S0 and S1 are expressed by equations below. A cyclic shift amount of the short sequence S0 is m0, and a cyclic shift amount of the short sequence S1 is m1.

[Equation 4]

s₀^{(m}^{₀}⁾(n)=\tilde{s}((n+m₀)mod 31)

s₁^{(m}^{₁}⁾(n)=\tilde{s}((n+m₁)mod 31) (4)

In set 1, the second synchronization signal sequences d2 generated according to Equations 2 to 4 are mapped to the OFDM symbols and subcarriers that the second synchronization signals are arranged. A sequence length of the second synchronization signal sequence d2 can be the same as the number of resource elements that the synchronization signal is arranged in one slot in set 1. The sequence length of the second synchronization signal sequence d2 can be the same as the number of resource elements that the synchronization signal is arranged in one subframe in set 1. Assuming that the number of resource elements to which the synchronization signals are mapped in set 1 is r*s1, the sequence length of the second synchronization signal sequence d2 is r*s1. A sequence length of the first synchronization signal sequence d1(n) arranged in each of set 1 and set 2 is also r*s1. FIG. 6 illustrates an example of a case that s1=1, s1 being the number of OFDM symbols that the synchronization signals are arranged in set 1. To be more specific, in set 1 in FIG. 7, the second synchronization signal sequence d2 with a sequence length r is mapped to the number r of subcarriers constituting one OFDM symbol (OFDM symbol #5).

In set 1, the second synchronization signal sequences d1(n) generated according to Equations 2 to 4 from a certain combination of m0 and m1 are mapped to the frequency domain in the OFDM symbol #5 that the second synchronization signal is arranged (a mapping rule for the frequency domain is similar to a rule described in FIG. 8). The terminal apparatus 20 uses the second synchronization signal arranged in the OFDM #5 to detect the cell ID and acquire the frame synchronization. Here, assuming that the number of the combinations of m0 and m1 in accordance with which the second synchronization signal sequence d2 is specified is y1, the number of cell IDs specified by the second synchronization signal in set 1 (the number of cell IDs of N_ID̂(1)) is y1*s1. FIG. 8 illustrates an example of a case of s1=1, the number of cell IDs specified by the second synchronization signal is y1 in set 1. Here, y1*s1 second synchronization signal sequences specified in accordance with the combination of m0 and m are also called the second synchronization signal sequence candidates. The first synchronization signal sequence candidates and the second synchronization signal sequence candidates are also called collectively synchronization signal sequence candidates.

In set 2, the multiple second synchronization signal sequences d2 generated according to Equations 2 to 4 are mapped to the OFDM symbols and subcarriers that the second synchronization signals are arranged. In set 2, the second synchronization signal sequence d2 is mapped to the frequency domain for each OFDM symbol (a mapping rule for the frequency domain is similar to the rule described in FIG. 8). In set 2, assuming that the number of resource elements to which the second synchronization signals are mapped is r*s2, it is satisfied that r*s2=r*a*s1. To be more specific, “a” first synchronization signal sequences d2 are aligned in the time domain. The synchronization signal of set 2 is generated using the first synchronization signal sequence d2 in set 1 as a base synchronization signal sequence.

In set 2, each of “a” second synchronization signal sequences d2 aligned in the time domain is selected from any of y1 combinations of m0 and m1. In FIG. 7, the second synchronization signals are mapped to five OFDM symbols of OFDM symbol numbers #25 to #29. The combination of m0 and m for the second synchronization signal sequence d2 mapped to the OFDM symbol number #25 is selected from any of y1 combinations. The combination of m0 and m for the second synchronization signal sequence d2 mapped to each of the OFDM symbol numbers #26 to #29 is similarly selected from any of y1 combinations.

The terminal apparatus 20 uses a series of the first synchronization signal sequences arranged in the OFDM #25 to #29 (multiple second synchronization signal sequences d2) to detect the cell ID and acquire the frame synchronization in set 2 in FIG. 7. In set 2, the cell ID (N_ID̂(1)) specified by the second synchronization signal is determined in accordance with a combination of the second synchronization signal sequences d2. In set 2 in FIG. 7, the number of cell IDs specified by the second synchronization signal sequences d2 is a*y1.

In set 3, the multiple second synchronization signal sequences d2 generated according to Equations 2 to 4 are mapped to the OFDM symbols and subcarriers that the second synchronization signals are arranged. In set 3, the second synchronization signal sequence d2 is mapped to the frequency domain for each OFDM symbol (a mapping rule for the frequency domain is similar to the rule described in FIG. 8). In set 3, assuming that the number of resource elements to which the second synchronization signals are mapped is r*s3, it is satisfied that r*s3=r*b*s1. The first synchronization signal sequences d2 mapped to the frequency domain are aligned in the time domain in “b” rows. The synchronization signal of set 3 is generated using the first synchronization signal sequence d2 in set 1 as a base synchronization signal sequence.

In set 3, each of “b” second synchronization signal sequences d2 aligned in the time domain is selected from any of y1 combinations of m0 and m1. In FIG. 7, the second synchronization signals are mapped to 40 OFDM symbols of OFDM symbol numbers #200 to #239. The combination of m0 and m1 for the second synchronization signal sequence d2 mapped to the OFDM symbol number #200 is selected from any of y1 combinations. The combination of indices m0 and m for the second synchronization signal sequence d2 mapped to each of the OFDM symbol numbers #201 to #239 is similarly selected from any of y1 combinations.

The terminal apparatus 20 uses a series of synchronization signal sequences arranged in the OFDM #200 to #239 (multiple second synchronization signal sequences d2) to detect the cell ID and acquire the frame synchronization in set 3, In set 3, the cell ID (N_ID̂(1)) specified by the second synchronization signal is determined in accordance with a combination of the second synchronization signal sequences d2. In set 3 in FIG. 7, the number of cell IDs specified by the second synchronization signal is b*y1.

In the case that the terminal apparatus establishes synchronization in set 1, the base station apparatus can transmit the indices m0 and m1 for the second synchronization signal sequence d2 arranged in each of the OFDM symbol numbers #25 to #29 in set 2 by using the region of set 1. The base station apparatus can notify the cell ID specified by a series of the second synchronization signal sequences d2 arranged in each of the OFDM symbol numbers #25 to #29 in set 2 by using the region of set 1.

Similarly, in the case that the terminal apparatus establishes synchronization in set 1, the base station apparatus can transmit the indices m0 and m1 for the second synchronization signal sequence d2 arranged in each of the OFDM symbol numbers #200 to #239 in set 3 by using the region of set 1. The base station apparatus can notify the cell ID specified by a series of the first synchronization signal sequences d2 arranged in each of the OFDM symbol numbers #200 to #239 in set 2 by using the region of set 1. This causes the base station apparatus to explicitly search for a sequence only for the first synchronization signal sequence in the cell search in sets 2 and 3. This makes it possible to reduce the synchronization signal sequence candidates which are used to establish synchronization by the terminal apparatus, reducing load in establishing synchronization by the terminal apparatus.

As described above, in the present embodiment, the base synchronization signal sequences d2 are combined depending on the sampling frequency/OFDM symbol length for each radio parameter set. This can prevent synchronization acquisition accuracy from deteriorating due to the sampling error even in the case of high sampling frequency. Each of the base synchronization signal sequences d2 combined is configured with the cyclic shift amount for the synchronization signal sequence as a base therefor. In each radio parameter set, the cell ID is specified by a series of synchronization signals constituted by the combination of the base synchronization signal sequences. This increases the number of cell IDs specified by the second synchronization signal in set 2 and set 3, which can prevent the accuracy in the synchronization signal acquisition and cell ID detection from deteriorating due to interference from another cell even in the case of dense cell arrangement or rough cell arrangement. The present embodiment uses the M—sequence as the second synchronization signal sequence, but is not limited thereto, and may use any sequence so long as the terminal apparatus can acquire the frame synchronization and detect the cell ID by means of the sequence.

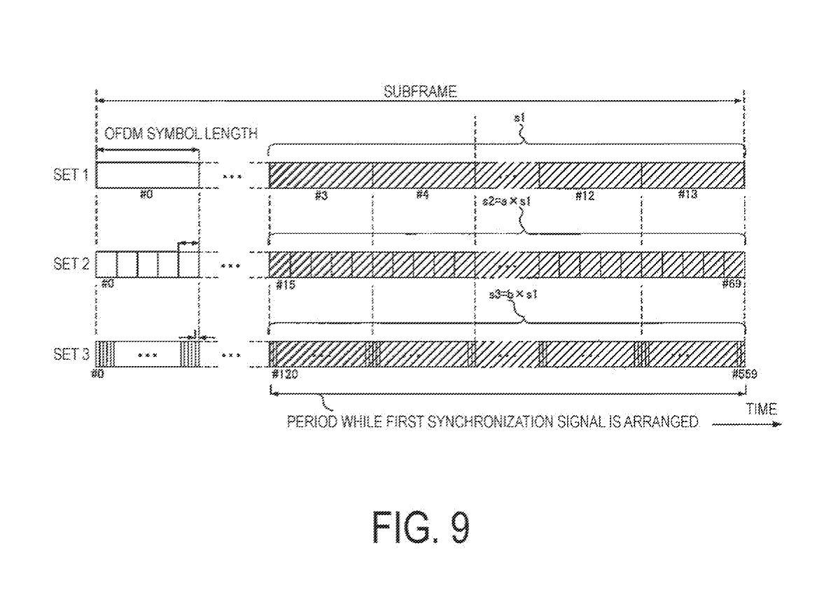

FIG. 9 is a diagram illustrating another configuration example of the OFDM symbols per a subframe in the radio access technology according to the present embodiment. Set 1 to set 3 in FIG. 9 correspond to those in FIG. 2 to FIG. 6. Set 1 is an example constituted of 14 OFDM symbols per one subframe. Each subframe is constituted by two slots. Set 1 is constituted of seven OFDM symbols per one slot. Set 2 is an example constituted of 70 OFDM symbols per one subframe. Set 2 is constituted of 35 OFDM symbols per one slot. Set 3 is an example constituted of 560 OFDM symbols per one subframe. Set 3 is constituted of 280 OFDM symbols per one slot.

In the example in FIG. 9, the sampling frequencies in set 2 and set 3 are five times and 40 times the sampling frequency in set 1, respectively. The OFDM symbol lengths in set 2 and set 3 are one fifth and one fortieth of the OFDM symbol length in set 1, respectively.

FIG. 9 illustrates the subframe (subframe #0 or #5 in FIG. 5) in which the synchronization signal is arranged in the radio frame. In FIG. 9, the first synchronization signal is arranged in the OFDM symbol of a right-up hatched portion. In set 1, the first synchronization signals are mapped to multiple OFDM symbols constituting one subframe (OFDM symbol numbers #3 to #13 in set 1). In FIG. 8, the OFDM symbol of a white solid portion is an OFDM symbol that the synchronization signal is not arranged. For example, the OFDM symbols #0 to #2 in FIG. 9 are periods where the Downlink Control Information is arranged, and thus the synchronization signals are not mapped to the OFDM symbols #0 to #2. In set 1, set 2, and set 3, lengths of times to which the synchronization signals are mapped is identical. In set 1, set 2, and set 3, the number of OFDM symbols that the synchronization signals are arranged are different from each other. In FIG. 9, the number of OFDM symbols for the synchronization signals arranged in set 2 is five times the number of OFDM symbols for the synchronization signal arranged in set 1. The number of OFDM symbols for the synchronization signals arranged in set 3 is 40 times the number of OFDM symbols for the synchronization signal arranged in set 1. FIG. 9 illustrates an example indicating that the OFDM symbol that the synchronization signal is arranged is configured according to a relationship with the sampling frequency and the OFDM symbol length, and an aspect of the present invention is not limited to such parameter values.

In FIG. 9, an example is illustrated in which the first synchronization signals are arranged in some of the OFDM symbols constituting one subframe. The first synchronization signal can be used to acquire the symbol synchronization. The first synchronization signal can be used to acquire the frame synchronization. The first synchronization signal can be used to detect the cell ID.

In FIG. 9, a sequence length used for the first synchronization signal is determined according to the number of subcarriers and the number of OFDM symbols that the first synchronization signal is arranged. Here, assuming that the number of OFDM symbols that the synchronization signals are arranged in set 1, set 2, and set 3 are s1, s2, and s3, respectively, it is satisfied that s2=a*s1 and s3=b*s2. For example, a is a sampling frequency ratio between set 1 and set 2, and b is a sampling frequency ratio between set 1 and set 3. In FIG. 9, s1=11, s2=55, s3=440, a=5, and b=40. The number of subcarriers that the synchronization signals are arranged in set 1 to set 3 is r (in FIG. 5 and FIG. 6).

In set 1 in FIG. 9, the first synchronization signal sequence d1(n) generated with a certain index u in the table in FIG. 7 is mapped to the OFDM symbols and subcarriers that the first synchronization signals are arranged.

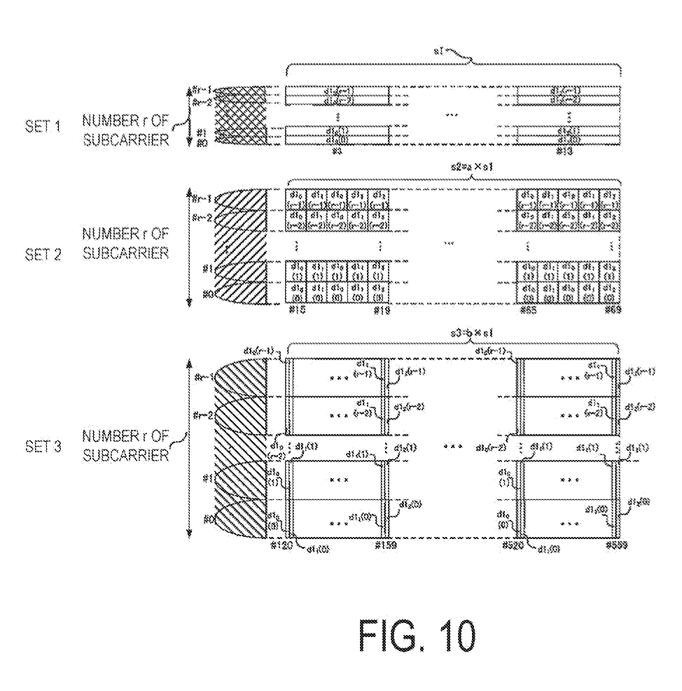

FIG. 10 is a diagram illustrating another arrangement example of the first synchronization signal according to the present embodiment. Set 1 to set 3 in FIG. 10 correspond to those in FIG. 2 to FIG. 6 and FIG. 9. In FIG. 10, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. The sequence length of the first synchronization signal sequence d1(n) can be the same as the number of resource elements that the synchronization signal is arranged in one OFDM symbol in set 1. To be more specific, assuming that the number of resource elements to which the synchronization signals are mapped in set 1 is r*s1, the sequence length of the first synchronization signal sequence d1(n) is r. The sequence length of the first synchronization signal sequence d1(n) arranged in each of set 2 and set 3 in FIG. 10 is also r.

In set 1 in FIG. 10, the multiple first synchronization signal sequences d1_u(n) generated with a certain index u in the table of the index u are mapped to the OFDM symbols and subcarriers that the first synchronization signals are arranged. In set 1, the first synchronization signal sequences d1(n) are generated by being mapped to the frequency domain for each OFDM symbol. In set 1, the number of first synchronization signal sequences d1(n) aligned in the time domain is s1.

In set 1 in FIG. 10, each of“s1” first synchronization signal sequences d1(n) aligned in the time domain is selected from any of x1 indices u. In FIG. 10, the first synchronization signals are mapped to 11 OFDM symbols of OFDM symbol numbers #3 to #13. The index u of the first synchronization signal sequence d1(n) mapped to the OFDM symbol number #3 is selected from any of x1 indices. FIG. 10 illustrates an example of a case that the first synchronization signal sequence d1_0(n) with u=0 is mapped to the OFDM symbol number #3. The indices u of the first synchronization signal sequences d1(n) mapped to OFDM symbol numbers #4 to #13 are similarly selected from any of x1 indices.

The terminal apparatus 20 uses a series of synchronization signal sequences arranged in the OFDM symbols #3 to #13 to detect the cell ID and acquire the symbol synchronization. The terminal apparatus 20 can also use a series of synchronization signal sequences arranged in the OFDM symbols #3 to #13 to acquire the frame synchronization. In set 1 in FIG. 10, the number of cell IDs specified by a combination of the first synchronization signal sequences d1(n) is s1*x1. To be more specific, in set 1, the number of cell IDs specified by the first synchronization signals is s1*x1.

In set 2, the multiple first synchronization signal sequences d1(n) generated with the index u are mapped to the OFDM symbols and subcarriers that the first synchronization signals are arranged. In set 2, the first synchronization signal sequence d1(n) is mapped to the frequency domain for each OFDM symbol. In set 2, assuming that the number of resource elements to which the synchronization signals are mapped is r*s2, it is satisfied that r*s2=r*a*s1. The first synchronization signal sequences d1(n) mapped to the frequency domain are aligned in the time domain in a*s1 rows.

In set 2 in FIG. 10, each of “a*s1” first synchronization signal sequences d1(n) aligned in the time domain is selected from any of x1 indices u. In FIG. 10, the first synchronization signals are mapped to the OFDM symbols of OFDM symbol numbers #15 to #69. The index u of the first synchronization signal sequence d1(n) mapped to the OFDM symbol number #15 is selected from any of x1 indices. FIG. 10 illustrates an example of a case that the first synchronization signal sequence d1_0(n) with u=0 is mapped to the OFDM symbol number #15. The indices u of the first synchronization signal sequences d1(n) mapped to OFDM symbol numbers #16 to #69 are similarly selected from any of x1 indices.

The terminal apparatus 20 uses a series of synchronization signal sequences arranged in the OFDM #16 to #69 (a block of multiple first synchronization signal sequences d1(n)) to detect the cell ID and acquire the symbol synchronization in set 2 in FIG. 10. The terminal apparatus 20 can also use a series of synchronization signal sequences arranged in the OFDM #16 to #69 to acquire the frame synchronization. In set 2, the cell ID (N_ID̂(2)) specified by the first synchronization signal is determined in accordance with a combination of the first synchronization signal sequences d1(n). In set 2 in FIG. 10, the number of cell IDs specified by the combination of the first synchronization signal sequences d1(n) is a*s1*x1.

In set 3, the multiple first synchronization signal sequences d1(n) generated with the index u are mapped to the OFDM symbols and subcarriers that the first synchronization signals are arranged. In set 3, the first synchronization signal sequence d1(n) is mapped to the frequency domain for each OFDM symbol. In set 3, assuming that the number of resource elements to which the first synchronization signals are mapped is r*s3, it is satisfied that r*s3=r*b*s1. Specifically, “b*s1” first synchronization signal sequences d1(n) are aligned in the time domain.

In set 3 in FIG. 10, each of “b*s1” first synchronization signal sequences d1(n) aligned in the time domain is selected from any of x1 indices u. In FIG. 10, the synchronization signals are mapped to the OFDM symbols of OFDM symbol numbers #120 to #599. The index u of the first synchronization signal sequence d1(n) mapped to the OFDM symbol number #120 is selected from any of x1 indices. FIG. 10 illustrates an example of a case that the first synchronization signal sequence d1_0(n) with u=0, (n=0, 1, . . . , r−1) is mapped to the OFDM symbol number #120. The indices u of the first synchronization signal sequences d1(n) mapped to OFDM symbol numbers #121 to #599 are similarly selected from any of x1 indices.

The terminal apparatus 20 uses a series of synchronization signal sequences arranged in the OFDM #121 to #599 (multiple first synchronization signal sequences d1(n)) to detect the cell ID and acquire the symbol synchronization. The terminal apparatus 20 can also use a series of synchronization signal sequences arranged in the OFDM #121 to #599 to acquire the frame synchronization. In set 3, the cell ID (N_ID̂(2)) specified by the first synchronization signal is determined in accordance with a combination of the first synchronization signal sequences d1(n). In set 3 in FIG. 10, the number of cell IDs specified by the first synchronization signal is b*s1*x1.

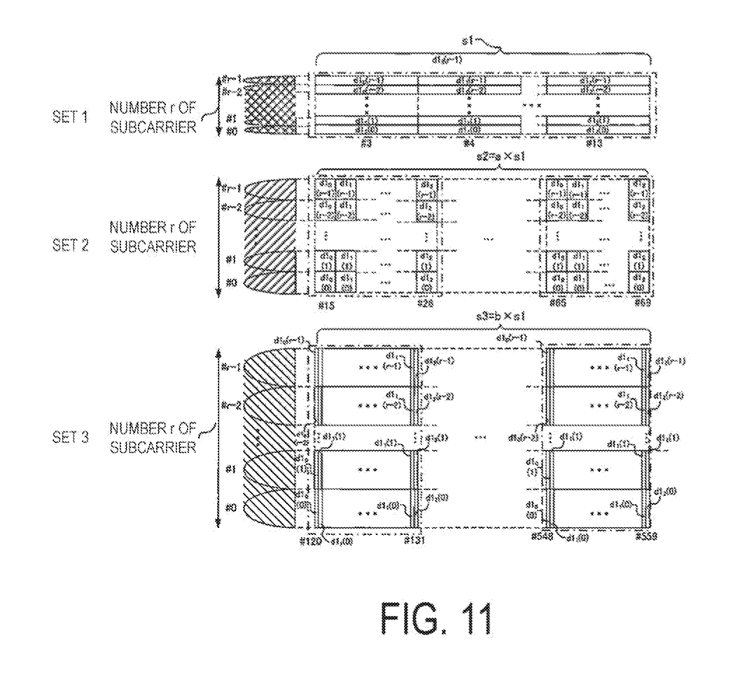

FIG. 11 is a diagram illustrating another arrangement example of the first synchronization signal according to the present embodiment. Set 1 to set 3 in FIG. 11 correspond to those in FIG. 2 to FIG. 7 and FIG. 9. In FIG. 11, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. The number r of subcarriers in set 1 in FIG. 11 corresponds to the subcarriers that the synchronization signals are arranged in the region of set 1 in FIG. 4. Similarly, the number r of subcarriers in set 2 in FIG. 11 corresponds to the subcarriers that the synchronization signals are arranged in the region of set 2 in FIG. 4. The number r of subcarriers in set 3 in FIG. 11 corresponds to the subcarriers that the synchronization signals are arranged in the region of set 3 in FIG. 4. FIG. 11 illustrates an example of a case that the synchronization signals are arranged in the identical time length in set 1 to set 3.

In set 1, the multiple first synchronization signal sequences d1(n) generated with a certain index u in the table of the index u are mapped to the OFDM symbols and subcarriers that the first synchronization signals are arranged. The first synchronization signals in set 1 are generated by that the first synchronization signal sequences d1(n) are mapped to the frequency domain for each OFDM symbol. In set 1, the number of synchronization signal sequences d1(n) aligned in the time domain is s1.

In set 1 in FIG. 11, each of “s1” first synchronization signal sequences d1(n) aligned in the time domain is selected from any of x1 indices u. In FIG. 11, the first synchronization signals are mapped to 11 OFDM symbols of OFDM symbol numbers #3 to #13. The index u of the first synchronization signal sequence d1(n) mapped to the OFDM symbol number #3 is selected from any of x1 indices. FIG. 11 illustrates an example of a case that the first synchronization signal sequence d1_0(n) with u=0 is mapped to the OFDM symbol number #3. The indices u of the first synchronization signal sequences d1(n) mapped to OFDM symbol numbers #4 to #13 are similarly selected from any of x1 indices. FIG. 11 illustrates an example of a case that the first synchronization signal sequence d1_2(n) with u=2 is mapped to the OFDM symbol number #13.

The terminal apparatus 20 uses a series of synchronization signal sequences arranged in the OFDM #3 to #13 to detect the cell ID and acquire the symbol synchronization. The terminal apparatus 20 can also use a series of synchronization signal sequences arranged in the OFDM symbols #3 to #13 to acquire the frame synchronization. In set 1 in FIG. 11, the number of cell IDs specified by a combination of the first synchronization signal sequences d1(n) is s1*x1. To be more specific, in set 1, the number of cell IDs specified by the first synchronization signals is s1*x1.

In set 2, the multiple first synchronization signal sequences d1(n) generated with the index u are mapped to the OFDM symbols and subcarriers that the first synchronization signals are arranged. In set 2, the index u of the first synchronization signal sequence d1(n) arranged in set 1 is reflected. In FIG. 11, in a case that the indices u of the first synchronization signal sequences d1(n) arranged in the OFDM symbols #3 to #13 in set 1 are (0, 1, 0, 1, . . . , 2) in this order, a similar index order (0, 1, 0, 1, . . . , 2 is repeated in set 2 (each range being surrounded by a dashed-dotted line in FIG. 11). Here, the range surrounded by the dashed-dotted line in FIG. 11 is called a first synchronization signal sequence group for set 1. In set 2, “a” first synchronization signal sequence groups are aligned in the time domain. To be more specific, in FIG. 11, the index order of the first synchronization signal sequences d1(n) arranged in the OFDM symbol #3 to #13 in set 1 is repeated in the OFDM symbols #15 to #26, OFDM symbols #27 to #38, . . . , OFDM symbols #65 to #69 in set 2.

In set 2 in FIG. 11, each of the first synchronization signal sequences d1(n) constituting the first synchronization signal sequence group is selected from any of x1 indices u. The terminal apparatus 20 uses a series of synchronization signal sequences constituting the first synchronization signal sequence group to detect the cell ID and acquire the symbol synchronization. The terminal apparatus 20 can also use a series of synchronization signal sequences arranged in the OFDM symbols #3 to #13 to acquire the frame synchronization. In set 2 in FIG. 11, the number of cell IDs specified by a combination of the first synchronization signal sequences d1(n) constituting the first synchronization signal sequence group is s*x1. To be more specific, in set 2, the number of cell IDs specified by the first synchronization signals is s1*x1.

In set 3 in FIG. 11, the multiple first synchronization signal sequences d1(n) generated with the index u are mapped to the OFDM symbols and subcarriers that the first synchronization signals are arranged. In set 3, the index u of the first synchronization signal sequence d1(n) arranged in set 1 is reflected. In FIG. 11, in a case that the indices u of the first synchronization signal sequences d1(n) arranged in the OFDM symbols #3 to #13 in set 1 are (0, 1, 0, 1, . . . , 2) in this order, a similar index order (0, 1, 0, 1, . . . , 2 is repeated in set 3 (each range being surrounded by a dashed-dotted line in set 3 in FIG. 11). In set 3, “b” first synchronization signal sequence groups are aligned in the time domain. To be more specific, in FIG. 11, the index order of the first synchronization signal sequences d1(n) arranged in the OFDM symbol #3 to #13 in set 1 is repeated in the OFDM symbols #120 to #131, . . . , OFDM symbols #548 to #559 in set 3,

In set 3 in FIG. 11, each of the first synchronization signal sequences d1(n) constituting the first synchronization signal sequence group is selected from any of x1 indices u. The terminal apparatus 20 uses a series of synchronization signal sequences constituting the first synchronization signal sequence group to detect the cell ID and acquire the symbol synchronization. The terminal apparatus 20 can also use a series of synchronization signal sequences arranged in the OFDM symbols #3 to #13 to acquire the frame synchronization. In set 3 in FIG. 11, the number of cell IDs specified by a combination of the first synchronization signal sequences d1(n) constituting the first synchronization signal sequence group is s1*x1. To be more specific, in set 3, the number of cell IDs specified by the first synchronization signals is s1*x1.

In FIGS. 8, 10, 11, in set 1, set 2, and set 3, the synchronization signal sequences d1 and d2 are mapped ascending order of the subcarrier number, but the order may be changed for each OFDM symbol. For example, a synchronization signal sequence is mapped in ascending order of the subcarrier number for a certain OFDM symbol, and a synchronization signal sequence is mapped in descending order of the subcarrier number for another OFDM symbol. This allows the number of cell IDs specified by the synchronization signal to be increased.

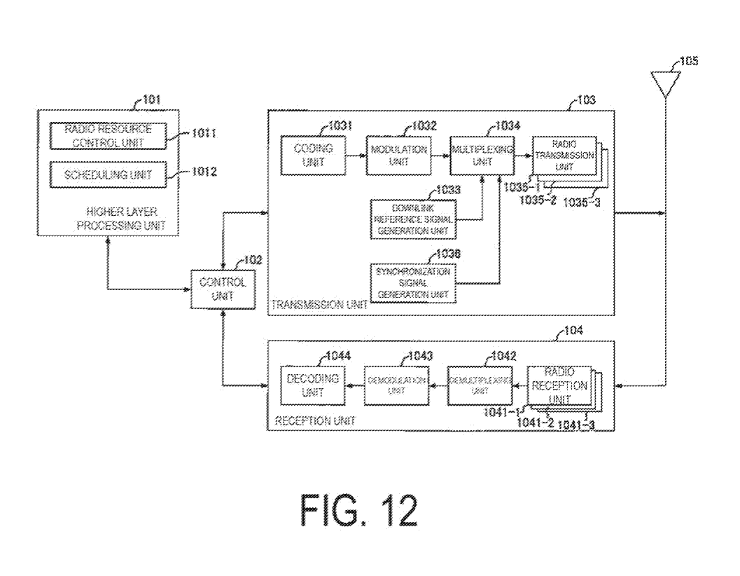

FIG. 12 is a schematic block diagram illustrating a configuration of the base station apparatuses 10 to 12 according to the present embodiment. As illustrated in FIG. 12, each of the base station apparatuses 10 to 12 is configured, including a higher layer processing unit (higher layer processing step) 101, a control unit (controlling step) 102, a transmission unit (transmitting step) 103, a reception unit (receiving step) 104, and a transmit and/or receive antenna 105. The higher layer processing unit 101 is configured, including a radio resource control unit (radio resource controlling step) 1011 and a scheduling unit (scheduling step) 1012. The transmission unit 103 is configured, including a coding unit (coding step) 1031, a modulation unit (modulating step) 1032, a downlink reference signal generation unit (downlink reference signal generating step) 1033, a multiplexing unit (multiplexing step) 1034, radio transmission units (radio transmitting step) 1035-1 to 1035-3, and a synchronization signal generation unit (synchronization signal generating step) 1036. The reception unit 104 is configured, including radio reception units (radio receiving step) 1041-1 to 1041-3, a demultiplexing unit (demultiplexing step) 1042, a demodulation unit (demodulating step) 1043, and a decoding unit (decoding step) 1044.

The higher layer processing unit 101 performs processing of the Medium Access Control (MAC) layer, a Packet Data Convergence Protocol (PDCP) layer, a Radio Link Control (RLC) layer, and a Radio Resource Control (RRC) layer. Furthermore, the higher layer processing unit 101 generates information necessary for control of the transmission unit 103 and the reception unit 104, and outputs the generated information to the control unit 102.

The higher layer processing unit 101 receives information of a terminal apparatus such as UE capability or the like, from the terminal apparatus. To rephrase, the terminal apparatus transmits its function to the base station apparatus by higher layer signaling. The higher layer processing unit 101 can include information indicating which radio parameter set (FIG. 2) the function of the terminal apparatus supports.

Note that in the following description, information of a terminal apparatus includes information indicating whether the stated terminal apparatus supports a prescribed function, or information indicating that the stated terminal apparatus has completed the introduction and test of a prescribed function. In the following description, information of whether the prescribed function is supported includes information of whether the introduction and test of the prescribed function have been completed.

For example, in a case where a terminal apparatus supports a prescribed function, the stated terminal apparatus transmits information (parameters) indicating whether the prescribed function is supported. In a case where a terminal apparatus does not support a prescribed function, the stated terminal apparatus does not transmit information (parameters) indicating whether the prescribed function is supported. In other words, whether the prescribed function is supported is reported by whether information (parameters) indicating whether the prescribed function is supported is transmitted. Information (parameters) indicating whether a prescribed function is supported may be reported using one bit of 1 or 0. For example, in a case that multiple parameter sets are present (FIG. 2), the terminal apparatus can transmit information indicating whether the radio parameters are supported on a parameter-by-parameter basis.

The radio resource control unit 1011 generates, or acquires from a higher node, the downlink data (the transport block), system information, the RRC message, the MAC CE, and the like. The radio resource control unit 1011 outputs the downlink data to the transmission unit 103, and outputs other information to the control unit 102. Furthermore, the radio resource control unit 1011 manages various configuration information of the terminal apparatuses.

The scheduling unit 1012 determines a frequency and a subframe to which the physical channels (downlink data channel and uplink data channel) are allocated, the coding rate and modulation scheme (or MCS) for the physical channels, the transmit power, and the like. The scheduling unit 1012 outputs the determined information to the control unit 102. The scheduling unit 1012 can allocate the physical channels to different radio parameter sets (FIG. 2).

The scheduling unit 1012 generates information to be used for the scheduling of the physical channels based on the result of the scheduling. The scheduling unit 1012 outputs the generated information to the control unit 102.

Based on the information input from the higher layer processing unit 101, the control unit 102 generates a control signal for controlling of the transmission unit 103 and the reception unit 104. The control unit 102 generates the Downlink Control Information, based on the information input from the higher layer processing unit 101, and outputs the generated information to the transmission unit 103.

The transmission unit 103 generates the downlink reference signal and the synchronization signal in accordance with the control signal input from the control unit 102, codes and modulates the HARQ indicator, the Downlink Control Information, and the downlink data that are input from the higher layer processing unit 101, multiplexes the HQRQ indicator channel, the downlink control channel, the downlink data channel, the downlink reference signal, and the synchronization signal, and transmits a signal generated by the multiplexing to the terminal apparatus 2 through the transmit and/or receive antenna 105.

The coding unit 1031 codes the HARQ indicator, the Downlink Control Information, and the downlink data that are input from the higher layer processing unit 101, in compliance with the coding scheme prescribed in advance, such as block coding, convolutional coding, or turbo coding, or in compliance with the coding scheme determined by the radio resource control unit 1011. The modulation unit 1032 modulates the coded bits input from the coding unit 1031, in compliance with the modulation scheme prescribed in advance, such as Binary Phase Shift Keying (BPSK), Quadrature Phase Shift Keying (QPSK), quadrature amplitude modulation (16QAM), 64QAM, or 256QAM, or in compliance with the modulation scheme determined by the radio resource control unit 1011.

The downlink reference signal generation unit 1033 generates, as the downlink reference signal, a sequence that is already learned to the terminal apparatus 20 and that is acquired in accordance with a rule prescribed in advance based on the physical cell identity (PCI, cell ID) for identifying the base station apparatuses 10 to 12, and the like.

The synchronization signal generation unit 1036 generates the synchronization signal sequence depending on the radio parameter set adopted for the transmission unit 103. The root and cyclic shift parameter used to generate the synchronization signal sequence in the synchronization signal generation unit 1036 can be configured based on the cell ID acquired from the higher layer processing unit 101. The synchronization signal generation unit 1036 can configure the sequence length of the synchronization signal sequence, based on information indicating the radio parameter set acquired from the higher layer processing unit 101.

The multiplexing unit 1034 multiplexes the modulated modulation symbol of each channel, and the generated downlink reference signal, synchronization signal, and Downlink Control Information. To be more specific, the multiplexing unit 1034 arranges the modulated modulation symbol of each channel, and the generated downlink reference signal, Downlink Control Information, and synchronization signal in the resource elements. For example, the respective signals are arranged in the resource elements illustrated in FIG. 3 to FIG. 7, FIG. 8 to FIG. 11. The multiplexing unit 1034 can interpret the resource element in which the synchronization signal is arranged, based on the information indicating the radio parameter set acquired from the higher layer processing unit 101.

Each of the radio transmission units 1035-1 to 1035-3 performs Inverse Fast Fourier Transform (IFFT) on the modulation symbol resulting from the multiplexing or the like, generates an OFDM symbol, attaches a cyclic prefix (CP) to the generated OFDM symbol, generates a baseband digital signal, converts the baseband digital signal into an analog signal, removes unnecessary frequency components through filtering, up-converts a result of the removal into a signal of a carrier frequency, performs power amplification, and outputs a final result to the transmit and/or receive antenna 105 for transmission.

The radio transmission units 1035-1 to 1035-3 are respectively associated with radio parameter sets 1 to 3 in FIG. 2. Each of the radio transmission units 1035-1 to 1035-3 performs inverse fast Fourier transform, based on the frequency bandwidth, subcarrier spacing, sampling frequency, the number of FFT points, and the like of the associated radio parameter set to generate an OFDM symbol. Moreover, filtering and up-converting to a carrier frequency are performed based the frequency bandwidth, subcarrier spacing, sampling frequency, the number of FFT points, and the like of the radio parameter set. The base station apparatuses 10 to 12 adopt the radio transmission units 1035-1 to 1035-3 depending on the adopted radio parameter sets. The antenna 105 is provided depending on the carrier frequency transmitted from the radio transmission unit 1035-1 to 1035-3.

In accordance with the control signal input from the control unit 102, the reception unit 104 demultiplexes, demodulates, and decodes the reception signal received from the terminal apparatus 20 through the transmit and/or receive antenna 105, and outputs information resulting from the decoding to the higher layer processing unit 101.

Each of the radio reception units 1041-1 to 1041-3 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio reception units 1041-1 to 1041-3 are respectively associated with radio parameter sets 1 to 3 in FIG. 2. Each of the radio transmission units 1041-1 to 1041-3 performs down-converting to a baseband signal, based on the frequency bandwidth, subcarrier spacing, sampling frequency, the number of FFT points and the like of the associated radio parameter set. The antenna 105 is provided depending on the carrier frequency received from the radio transmission unit 1041-1 to 1041-3.

The radio reception unit 1041 removes a portion corresponding to CP from the digital signal resulting from the conversion. The radio reception unit 1041 performs Fast Fourier Transform (FFT) on the signal from which the CP has been removed, extracts a signal in the frequency domain, and outputs the resulting signal to the demultiplexing unit 1042. Each of the radio transmission units 1041-1 to 1041-3 performs the CP removal and the FFT processing, based on the frequency bandwidth, subcarrier spacing, sampling frequency, the number of FFT points, and the like of the associated radio parameter set. The base station apparatuses 10 to 12 adopt the radio transmission unit 1041-1 to 1041-3 depending on the adopted radio parameter sets.

In the base station apparatus 10 to 12, the transmission unit 103 can adopt the radio parameter set different for the radio parameter set for the radio reception unit 104. For example, the base station apparatus can perform uplink radio transmission by using radio parameter set 1 and downlink radio transmission by using radio parameter set 3 with the terminal apparatus 20.

The demultiplexing unit 1042 demultiplexes the signal input from the radio reception units 1041-1 to 1041-3 into the uplink control channel, the uplink data channel, and the signal such as the uplink reference signal. The demultiplexing is performed based on radio resource allocation information that is determined in advance by the base station apparatuses 10 to 12 using the radio resource control unit 1011 and that is included in the uplink grant notified to the terminal apparatus 20.

The demultiplexing unit 1042 makes a channel compensation of the uplink control channel and the uplink data channel. The demultiplexing unit 1042 demultiplexes the uplink reference signal.

The demodulation unit 1043 performs Inverse Discrete Fourier Transform (IDFT) on the uplink data channel, acquires modulation symbols, and performs reception signal demodulation on each of the modulation symbols of the uplink control channel and uplink data channel in compliance with the modulation scheme prescribed in advance, such as BPSK, QPSK, 16QAM, 64QAM, 256QAM, or the like, or in compliance with the modulation scheme that the base station apparatus itself notified each terminal apparatus 20 in advance with the uplink grant.

The decoding unit 1044 decodes the coded bits of the uplink control channel and uplink data channel, which have been demodulated, at the coding rate in compliance with a coding scheme prescribed in advance, the coding rate being prescribed in advance or being notified in advance with the uplink grant to the terminal apparatus 2 by the base station apparatus itself, and outputs the decoded uplink data and uplink control information to the higher layer processing unit 101. In a case that the uplink data channel is re-transmitted, the decoding unit 1044 performs the decoding with the coded bits input from the higher layer processing unit 101 and retained in an HARQ buffer, and the demodulated coded bits.

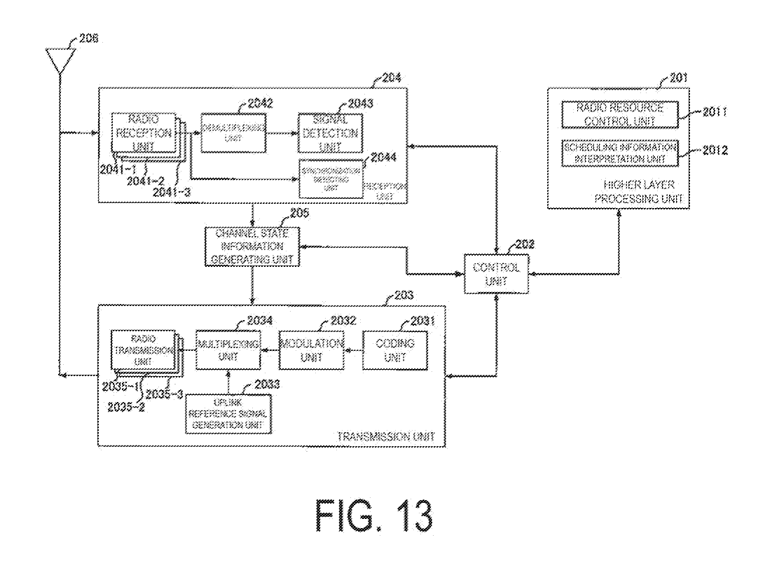

FIG. 13 is a schematic block diagram illustrating a configuration of the terminal apparatus 20 according to the present embodiment. As illustrated in FIG. 13, the terminal apparatus 20 is configured, including a higher layer processing unit (higher layer processing step) 201, a control unit (controlling step) 202, a transmission unit (transmitting step) 203, a reception unit (receiving step) 204, a channel state information generating unit (channel state information generating step) 205, and a transmit and/or receive antenna 206. The higher layer processing unit 201 is configured, including a radio resource control unit (radio resource controlling step) 2011 and a scheduling information interpretation unit (scheduling information interpreting step) 2012. The transmission unit 203 is configured, including a coding unit (coding step) 2031, a modulation unit (modulating step) 2032, an uplink reference signal generation unit (uplink reference signal generating step) 2033, a multiplexing unit (multiplexing step) 2034, and radio transmission units (radio transmitting step) 2035-1 to 2035-3. The reception unit 204 is configured, including radio reception units (radio receiving step) 2041-1 to 2041-3, a demultiplexing unit (demultiplexing step) 2042, a signal detection unit (signal detecting step) 2043, and a synchronization detecting unit (synchronization detecting step) 2044.

The higher layer processing unit 201 outputs the uplink data (the transport block) generated by a user operation or the like, to the transmission unit 203. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmission unit 203, information indicating a terminal apparatus function supported by the terminal apparatus itself. The higher layer processing unit 201 can include information indicating which radio parameter set (FIG. 2) in the function of the terminal apparatus supports.

Furthermore, the radio resource control unit 2011 manages various configuration information of the terminal apparatuses itself. Furthermore, the radio resource control unit 2011 generates information to be mapped to each uplink channel, and outputs the generated information to the transmission unit 203. The radio resource control unit 2011 acquires configuration information of CSI feedback transmitted from the base station apparatus, and outputs the acquired information to the control unit 202.

The scheduling information interpretation unit 2012 interprets the Downlink Control Information received through the reception unit 204, and determines scheduling information. The scheduling information interpretation unit 2012 generates the control information in order to control the reception unit 204 and the transmission unit 203 in accordance with the scheduling information, and outputs the generated information to the control unit 202.

Based on the information input from the higher layer processing unit 201, the control unit 202 generates a control signal for controlling the reception unit 204, the channel state information generating unit 205, and the transmission unit 203. The control unit 202 outputs the generated control signal to the reception unit 204, the channel state information generating unit 205, and the transmission unit 203 to control the reception unit 204 and the transmission unit 203. The control unit 202 controls the transmission unit 203 to transmit CSI generated by the channel state information generating unit 205 to the base station apparatus.

In accordance with the control signal input from the control unit 202, the reception unit 204 demultiplexes, demodulates, and decodes a reception signal received from the base station apparatuses 10 to 12 through the transmit and/or receive antenna 206, and outputs the resulting information to the higher layer processing unit 201.

Each of the radio reception units 2041-1 to 2041-3 converts, by down-converting, a downlink signal received through the transmit and/or receive antenna 206 into a baseband signal, removes unnecessary frequency components, controls an amplification level in such a manner as to suitably maintain a signal level, performs orthogonal demodulation based on an in-phase component and an orthogonal component of the received signal, and converts the resulting orthogonally-demodulated analog signal into a digital signal.

The radio transmission units 2041-1 to 2041-3 are respectively associated with radio parameter sets 1 to 3 in FIG. 2. Each of the radio transmission units 2041-1 to 2041-3 converts, by down-converting, a downlink signal received through the transmit and/or receive antenna 206 into a baseband signal, removes unnecessary frequency components, and controls an amplification level in such a manner as to suitably maintain a signal level, based on the frequency bandwidth, subcarrier spacing, sampling frequency, the number of FFT points and the like of the associated radio parameter set. The transmit and/or receive antenna 206 is provided depending on the carrier frequency processed by each of the radio transmission units 2041-1 to 2041-3.

Each of the radio reception units 2041-1 to 2041-3 removes a portion corresponding to CP from the digital signal resulting from the conversion, performs fast Fourier transform on the signal from which CP has been removed, and extracts a signal in the frequency domain. Each of the radio transmission units 2041-1 to 2041-3 performs fast Fourier transform, based on the frequency bandwidth, subcarrier spacing, sampling frequency, the number of FFT points and the like of the associated radio parameter set to extract a signal in the frequency domain.

Each of the radio reception units 2041-1 to 2041-3 acquires the synchronization signal received through the transmit and/or receive antenna 206, based on the frequency bandwidth, subcarrier spacing, sampling frequency, the number of FFT points, and the like of the associated radio parameter set. Each of the radio reception units 2041-1 to 2041-3 performs filtering passing through the frequency bandwidth that the synchronization signal is arranged in the associated radio parameter set.

The demultiplexing unit 2042 demultiplexes the extracted signal into the HARQ indicator channel, the downlink control channel, the downlink data channel, and the downlink reference signal. Further, the demultiplexing unit 2042 makes a compensation of channels including the HARQ indicator channel and the downlink control channel, based on a channel estimation value of the desired signal obtained from the channel measurement, detects the downlink control information, and outputs the information to the control unit 202. The control unit 202 outputs the downlink data channel and the channel estimation value of the desired signal to the signal detection unit 2043.

The signal detection unit 2043, using the downlink data channel, the downlink control channel, and the channel estimation value, detects a signal, and outputs the detected signal to the higher layer processing unit 201. The signal detection unit 2043 can acquire information indicating the radio parameter sets adopted for uplink radio communication/downlink radio communication from the downlink data channel/downlink control channel. The signal detection unit 2043 can notify the higher layer processing unit 201 of the information indicating the radio parameter sets adopted for the uplink radio communication/downlink radio communication.

The synchronization detecting unit 2044 uses the acquired synchronization signals via the radio reception units 2041-1 to 2041-3 to perform the cell search. The synchronization detecting unit 2044 uses the synchronization signals of radio parameter sets 1 to 3 to perform the cell search via the radio reception units 2041-1 to 2041-3. The synchronization detecting unit 2044 detects the frame synchronization, the symbol synchronization, and the cell ID in the cell search procedure. The demultiplexing unit 2042 and the signal detection unit 2043 perform various processing in accordance with a symbol synchronization timing and frame synchronization timing acquired by the synchronization unit 2044.

The transmission unit 203 generates the uplink reference signal in accordance with the control signal input from the control unit 202, codes and modulates the uplink data (the transport block) input from the higher layer processing unit 201, multiplexes the uplink control channel, the uplink data channel, and the generated uplink reference signal, and transmits a result of the multiplexing to the base station apparatuses 10 to 12 through the transmit and/or receive antenna 206.

The coding unit 2031 codes the uplink control information input from the higher layer processing unit 201 in compliance with a coding scheme, such as convolutional coding or block coding. Furthermore, the coding unit 2031 performs turbo coding in accordance with information used for the scheduling of the uplink data channel.

The modulation unit 2032 modulates coded bits input from the coding unit 2031, in compliance with the modulation scheme notified with the Downlink Control Information, such as BPSK, QPSK, 16QAM, or 64QAM, or in compliance with a modulation scheme prescribed in advance for each channel.

The uplink reference signal generation unit 2033 generates a sequence acquired according to a rule (formula) prescribed in advance, based on a physical cell identity (PCI, also referred to as a cell ID or the like) for identifying the base station apparatuses 10 to 12, a bandwidth in which the uplink reference signal is arranged, a cyclic shift notified with the uplink grant, a parameter value for generation of a DMRS sequence, and the like.

In accordance with the control signal input from the control unit 202, the multiplexing unit 2034 rearranges modulation symbols of the uplink data channel in parallel and then performs Discrete Fourier Transform (DFT) on the rearranged modulation symbols. The multiplexing unit 2034 performs discrete Fourier transform, based on the number of FFT points, sampling frequency, and the like of the radio parameter set adopted for the uplink radio transmission by the terminal apparatus 20.

The multiplexing unit 2034 multiplexes the uplink control channel, the uplink data channel, and the generated uplink reference signal for each transmit antenna port. To be more specific, the multiplexing unit 2034 maps the uplink control channel, the uplink data channel, and the generated uplink reference signal in the resource elements for each transmit antenna port. The multiplexing unit 2034 maps the uplink control channel, the uplink data channel, and the generated uplink reference signal in the resource element for each transmit antenna port based on the radio parameter set adopted for the uplink radio transmission by the terminal apparatus 20. The multiplexing unit 2034 can acquire information indicating the radio parameter set adopted for the uplink radio transmission from the higher layer processing unit 201.

Each of the radio transmission units 2035-1 to 2035-3 performs Inverse Fast Fourier Transform (IFFT) on a signal resulting from the multiplexing, performs the modulation of SC-FDMA scheme, generates an SC-FDMA symbol, attaches CP to the generated SC-FDMA symbol, generates a baseband digital signal, converts the baseband digital signal into an analog signal, removes unnecessary frequency components, up-converts a result of the removal into a signal of a carrier frequency, performs power amplification, and outputs a final result to the transmit and/or receive antenna 206 for transmission.

The radio transmission units 2035-1 to 2035-3 are respectively associated with radio parameter sets 1 to 3 in FIG. 2. Information on the adopted radio parameter set can be acquired from the higher layer processing unit 201. Each of the radio transmission units 2035-1 to 2035-3 performs inverse fast Fourier transform based on the frequency bandwidth, subcarrier spacing, sampling frequency, the number of FFT points and the like of the associated radio parameter set to generate an SF-FDMA symbol or an OFDM symbol. Moreover, filtering and up-converting to a carrier frequency are performed, based the frequency bandwidth, subcarrier spacing, sampling frequency, the number of FFT points, and the like of the radio parameter set. The terminal apparatus 20 adopts the radio transmission units 2035-1 to 2035-3 depending on the adopted radio parameter sets. The antenna 206 is provided depending on the carrier frequency transmitted from the radio transmission unit 2035-1 to 2035-3.

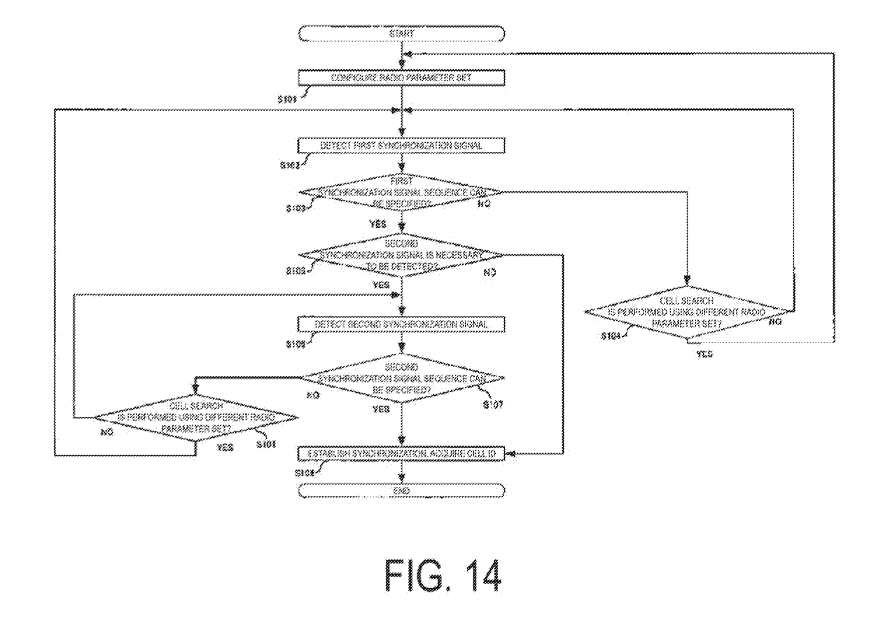

FIG. 14 is a diagram illustrating a cell search flow example for the terminal apparatus according to the present embodiment. The terminal apparatus 20 configures any of the supporting radio parameter sets (S101). In FIG. 2, the terminal apparatus 20 configures any of radio parameter sets 1 to 3. The terminal apparatus 20 detects the first synchronization signal, based on the configured radio parameter set (S102). For example, the terminal apparatus 20 uses any index u of the indices u to generates a replica of the first synchronization signal sequence d1. The terminal apparatus 20 performs correlation processing between the replica of the first synchronization signal sequence d1 and the first synchronization signal included in the reception signal.

In a case that the terminal apparatus 20 cannot specify the index u of the first synchronization signal sequence included in the reception signal as a result of the correlation processing (NO at S103), the terminal apparatus 20 selects whether to perform the cell search using a different radio parameter set or to perform the cell search again using the same radio parameter set (S104). In a case of the cell search using a different radio parameter set (YES at S104), the terminal apparatus 20 configures again a radio parameter set (that is, returns to S101). In a case of the cell search again using the same radio parameter set (NO at S104), the terminal apparatus 20 returns to the first synchronization signal detection processing (returns to S102).

In a case that the terminal apparatus 20 can specify the index u of the first synchronization signal sequence included in the reception signal as a result of the correlation processing (YES at S103), the terminal apparatus 20 establishes the symbol synchronization using the cell ID specified by the first synchronization signal. Here, the terminal apparatus 20 determines whether it is necessary to specify the cell ID using the second synchronization signal and acquire the frame synchronization in the radio parameter set configured at S101 (S105). In a case that the cell search is established only by the first synchronization signal in the configured radio parameter set (NO at S105), the terminal apparatus 20 specifies a cell ID which can be connected using only the first synchronization signal to establish the symbol synchronization and the frame synchronization (S108). For example, such a case is a case that the radio frame for the configured radio parameter set is the radio frame in FIG. 8.

In a case that it is necessary to specify the cell ID using the second synchronization signal and acquire the frame synchronization in the radio parameter set configured at S101 (YES at S105), the second synchronization signal is detected (S106). For example, in a case that it is necessary to use the first synchronization signal and the second synchronization signal in the cell search in the configured radio parameter set (in the case of the radio frame in FIG. 6), the terminal apparatus 20 detects the second synchronization signal.

In a case that the terminal apparatus 20 can specify m0 and m1 of the second synchronization signal sequence as a result of detecting the second synchronization signal (YES at S107), the terminal apparatus 20 can acquire the cell ID specified by the second synchronization signal and the frame synchronization. Then, the terminal apparatus 20 can use the cell ID specified by the first synchronization signal acquired at S105 and the cell ID specified by the second synchronization signal to acquire the cell ID of the cell which can be connected (S108).

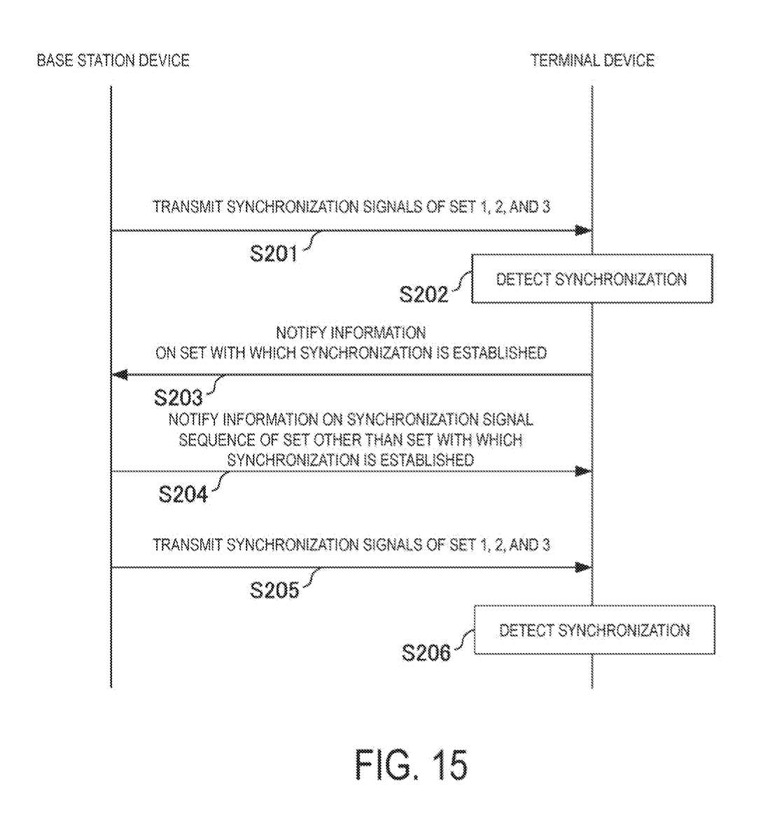

FIG. 15 is a diagram illustrating a sequence example of the cell search according to the present embodiment. FIG. 15 illustrates an example in which the base station apparatus assists information on the synchronization signal sequence with respect to the terminal apparatus. The base station apparatus transmits the synchronization signal sequences of set 1 to set 3 (S201). Assuming that the number of synchronization signal sequence candidates of each of set 1 to set 3 is x, the terminal apparatus uses replicas of 3*x synchronization signal sequence candidates and the synchronization signals transmitted at S201 by the base station apparatus to perform the synchronization detection (S202).

In a case that the terminal apparatus establishes synchronization with any of set 1 to set 3, the terminal apparatus notifies information on the set with which the synchronization is established (S203). The information on the set with which the synchronization is established may be information specifying the set with which the synchronization is established. At S203, the terminal apparatus can notify the base station apparatus of the capability.

Once the base station apparatus specifies the set with which the synchronization is established, the base station apparatus uses a downlink signal of the set with which the synchronization is established to notify information specifying a synchronization signal sequence of other set than the set with which the synchronization is established (S204). At this time, the base station apparatus can consider the capability. The information specifying the synchronization signal sequence is the root of the synchronization signal sequence, the cell ID associated with the synchronization signal sequence, and the like.

In a case that the terminal apparatus performs the synchronization detection using the synchronization signal received next (S205), the terminal apparatus uses the synchronization signal sequence candidate in a range of the information specifying the synchronization signal sequence received at S204 to perform the synchronization detection (S206). This makes it possible to reduce the synchronization signal sequence candidates which are searched by the terminal apparatus in order to establish synchronization.

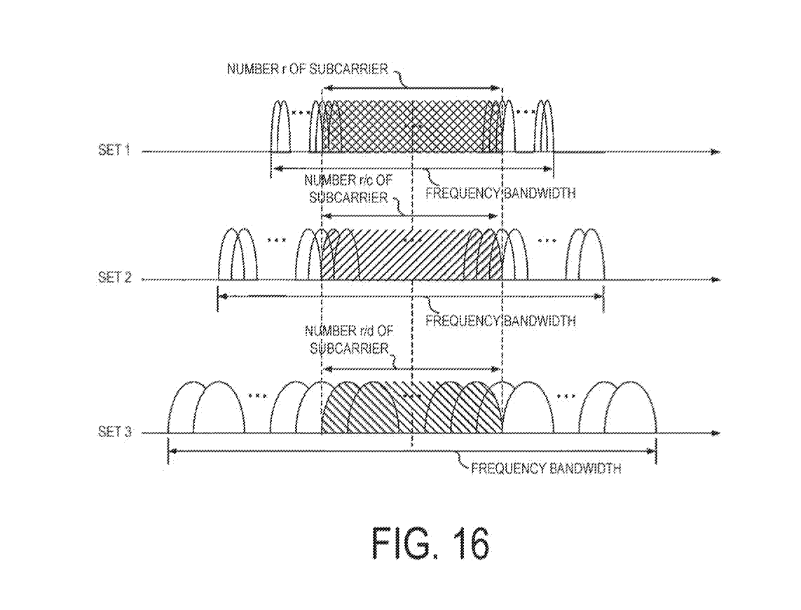

FIG. 16 is a diagram illustrating another example of the OFDM subcarrier configuration in an embodiment according to the present embodiment. FIG. 16 illustrates an example in which, in one radio access technology including multiple radio parameter sets, the frequency bandwidth that the synchronization signal is arranged is configured to be identical among the multiple radio parameters.

Set 1 to set 3 in FIG. 16 correspond to those in FIGS. 2 to 4. In FIG. 16, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. In FIG. 16, each of the subcarriers of white solid portions is a subcarrier where the downlink signal other than the synchronization signal is arranged. In FIG. 16, the subcarrier where the synchronization signal is arranged is arranged at a center of the frequency bandwidth available in each set. In FIG. 16, the frequency bandwidth that the synchronization signal is arranged is identical among set 1 to set 3, The frequency bandwidth that the synchronization signal is arranged can be configured in a frequency bandwidth constituting one resource block. Moreover, the frequency bandwidth that the synchronization signal is arranged can be configured in frequency bandwidths constituting multiple resource blocks.

In set 1, in a case that the number of subcarriers constituting one resource block is 12, and the synchronization signals are arranged over 6 resource blocks, the frequency bandwidth that 72 subcarriers are arranged is a bandwidth that the synchronization signals are arranged. In a case that the terminal apparatus 20 uses a bandpass filter in order to acquire the synchronization signal, the synchronization signal is arranged taking a guard band into consideration. For example, the synchronization signals are arranged in 63 subcarriers of 72 subcarrier described above.

A synchronization signal arrangement bandwidth in set 2 is the same as the synchronization signal arrangement bandwidth in this set 1. In FIG. 16, the subcarrier spacing of set 2 is wider than the subcarrier spacing of set 1, and thus the number of subcarriers in the synchronization signal arrangement bandwidth in set 2 is less than the number of subcarriers in the synchronization signal arrangement bandwidth in set 1. In FIG. 16, the subcarrier spacing of set 3 is wider than the subcarrier spacing of set 2, and thus the number of subcarriers in the synchronization signal arrangement bandwidth in set 3 is less than the number of subcarriers in the synchronization signal arrangement bandwidth in set 2.

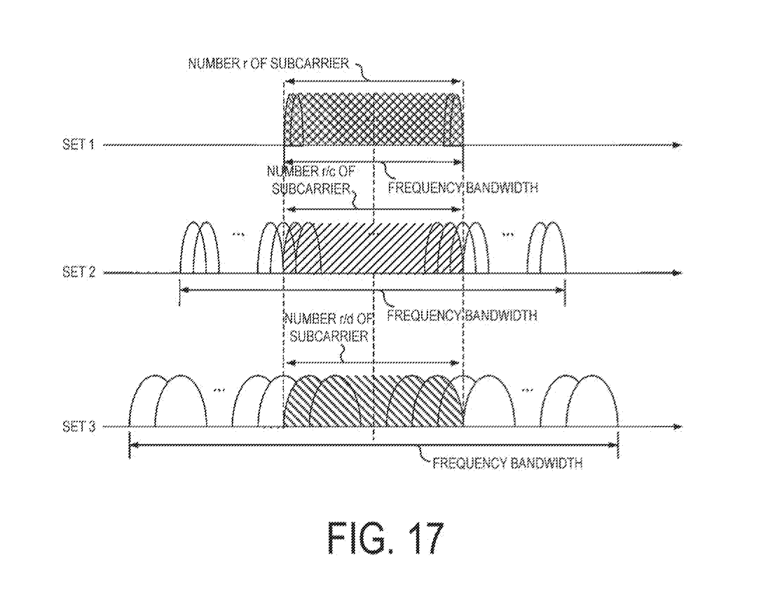

FIG. 17 is a diagram illustrating another example of the OFDM subcarrier configuration according to the present embodiment. FIG. 17 illustrates another example in which, in one radio access technology including multiple radio parameter sets, the frequency bandwidth that the synchronization signal is arranged is configured to be identical among the multiple radio parameters.

Set 1 to set 3 in FIG. 17 correspond to those in FIG. 2 to 4. In FIG. 17, each of the subcarriers of cross-hatched portions is a subcarrier where the synchronization signal of set 1 is arranged. Each of the subcarriers of right-up hatched portions is a subcarrier where the synchronization signal of set 2 is arranged. Each of the subcarriers of right-down hatched portions is a subcarrier where the synchronization signal of set 3 is arranged. In FIG. 17, the subcarrier where the synchronization signal is arranged at a center of the frequency bandwidth available in each set. In FIG. 17, the synchronization signals are arranged in the frequency bandwidth constituting the frequency bandwidth available in set 1. The frequency bandwidth that the synchronization signal is arranged is identical among set 1 to set 3. Here, assume that in FIG. 16 and FIG. 17, the number of subcarriers in the frequency bandwidth that the synchronization signal of set 1 is arranged is r. Assume that in FIG. 16 and FIG. 17, the number of subcarriers in the frequency bandwidth that the synchronization signal of set 2 is arranged is r/c. Assume that in FIG. 16 and FIG. 17, the number of subcarriers in the frequency bandwidth that the synchronization signal of set 3 is arranged is r/d. The numerals c and d are values determined depending on the sampling frequency and the number of FFT points of set 1 to set 3.

As describe above, by making the frequency bandwidth that the synchronization signals are arranged common among the multiple radio parameter sets included in one radio access technology, the identical bandpass filter can be used to acquire the synchronization signal.

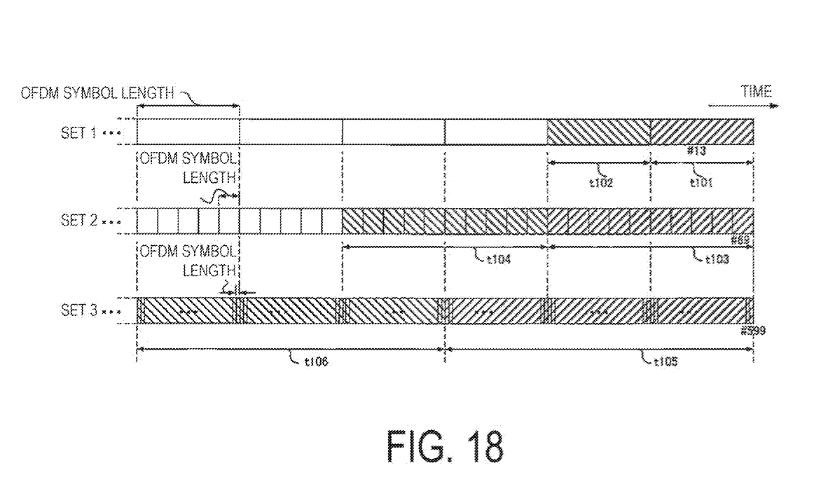

FIG. 18 is a diagram illustrating another configuration example of the OFDM symbols per a subframe in the radio access technology according to the present embodiment. Set 1 to set 3 in FIG. 18 correspond to those in FIGS. 2 to 4, FIG. 16, and FIG. 17. Set 1 is an example in which one subframe is constituted by 14 OFDM symbols. Each subframe is constituted by two slots. Set 1 is configured of seven OFDM symbols per one slot. Set 2 is an example configured of 70 OFDM symbols per one subframe. Set 2 is configured of 35 OFDM symbols per one slot. Set 3 is an example configured of 560 OFDM symbols per one subframe. Set 3 is configured of 280 OFDM symbols per one slot.

FIG. 18 illustrates a subframe in which a synchronization signal is arranged in a radio frame. In FIG. 18, the first synchronization signal is arranged in the OFDM symbol of a right-up hatched portion. In FIG. 18, the second synchronization signal is arranged in the OFDM symbol of a left-up hatched portion. In FIG. 18, the OFDM symbol of a white solid portion is an OFDM symbol that the synchronization signal is not arranged. In FIG. 16, t101 represents a time length that the first synchronization signal is arranged for set 1. A reference sign t102 represents a time length that the second synchronization signal is arranged for set 1. A reference sign t103 represents a time length that the first synchronization signal is arranged for set 2. A reference sign t104 represents a time length that the second synchronization signal is arranged for set 2. A reference sign t105 represents a time length that the first synchronization signal is arranged for set 3, A reference sign t106 represents a time length that the second synchronization signal is arranged for set 3, The arrangement of the first synchronization signal and the second synchronization signal in the time domain may be inverse.

In FIG. 18, the number of OFDM symbols for the time lengths t103 and t104 are c times the number of OFDM symbols for the time lengths t101 and t102. The number of OFDM symbols for the time lengths t105 and t106 are d times the number of OFDM symbols for the time lengths t101 and t102.

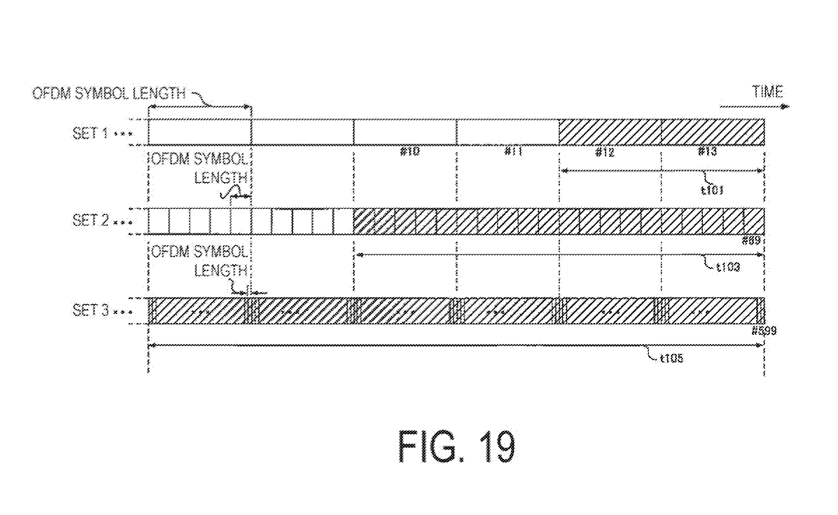

FIG. 19 is a diagram illustrating another configuration example of the OFDM symbols per a subframe in the radio access technology according to the present embodiment. Set 1 to set 3 in FIG. 19 correspond to those in FIGS. 2 to 4, 17, and 18. Set 1 is an example in which one subframe is constituted by 14 OFDM symbols. Each subframe is constituted by two slots. Set 1 is configured of seven OFDM symbols per one slot. Set 2 is an example configured of 70 OFDM symbols per one subframe. Set 2 is configured of 35 OFDM symbols per one slot. Set 3 is an example configured of 560 OFDM symbols per one subframe. Set 3 is configured of 280 OFDM symbols per one slot.

FIG. 19 is a diagram illustrating a subframe in which a synchronization signal is arranged in a radio frame. In FIG. 17, the first synchronization signal is arranged in the OFDM symbol of a right-up hatched portion. In FIG. 19, the OFDM symbol of a white solid portion is an OFDM symbol that the synchronization signal is not arranged. In FIG. 19, t101 represents a time length that the first synchronization signal is arranged for set 1.

A reference sign t103 represents a time length that the first synchronization signal is arranged for set 2. A reference sign t104 represents a time length that the second synchronization signal is arranged for set 2. A reference sign t105 represents a time length that the first synchronization signal is arranged for set 3.

In FIG. 19, the number of OFDM symbols for the time length t103 is c times the number of OFDM symbols for the time length t101. The number of OFDM symbols for the time length t105 is d times the number of OFDM symbols for the time length t101.

In FIGS. 18 and 19, the first synchronization signal is generated by combining the first synchronization signal sequences d1(n). For example, a Zadoff-Chu sequence expressed by Equation 1 can be used as the first synchronization signal sequence d1(n). In FIG. 18, the second synchronization signal is generated by combining the second synchronization signal sequences d2. For example, an M-sequence expressed by Equation 2 to Equation 4 can be used as the second synchronization signal sequence d2.

Assuming that the number of OFDM symbols that the first synchronization signal of set 1 is arranged is s1, the number of resource elements that the first synchronization signal of set 1 is arranged is r*s1. The resource elements that the first synchronization signal of set 1 is arranged is in a matrix of a frequency domain r and a time domain s1.

Here, assuming that a sequence length of the first synchronization signal sequence d1 in FIG. 18 and FIG. 19 is r, the first synchronization signal sequence d1 (n) is mapped to the frequency domain for each OFDM symbol. The index u of the first synchronization signal sequence d1(n) mapped to each OFDM symbol is selected from any of x1 indices u (x1=3 in FIG. 1). The first synchronization signal sequences d1(n) mapped to the frequency domain are aligned in the time domain in s1 rows.

Here, assuming that in set 1, a sequence length of the first synchronization signal sequence d1 in FIG. 18 and FIG. 19 is r*s1, the first synchronization signal sequence d1 is mapped in a matrix of a frequency domain r and a time domain s1. To be more specific, one first synchronization signal sequence d1 is mapped over the multiple OFDM symbols. For example, the first synchronization signal sequence d1 is preferentially mapped to the frequency domain.

Assuming that in FIG. 18 and FIG. 19, the number of OFDM symbols that the first synchronization signal of set 2 is arranged is s2=s1*c, the resource elements that the first synchronization signal of set 2 is arranged are in a matrix of a frequency domain (r/c) and a time domain (s1*c). Here, assuming that a sequence length of the first synchronization signal sequence d1 is r, the first synchronization signal sequence d1(n) is mapped over c OFDM symbols. The index u of the first synchronization signal sequence d1(n) mapped over c OFDM symbols is selected from any of x1 indices u (x1=3 in FIG. 1). The first synchronization signal sequence d1(n) mapped over c OFDM symbols is aligned in the time domain in s1 rows. In set 2, the number of cell IDs specified by the first synchronization signal is s1*x1.

Assuming that in FIG. 18 and FIG. 19, the number of OFDM symbols that the first synchronization signal of set 3 is arranged is s23s1*d, the resource elements that the first synchronization signal of set 2 is arranged are in a matrix of a frequency domain (r/d) and a time domain (s1*d). Here, assuming that a sequence length of the first synchronization signal sequence d1 is r, the first synchronization signal sequence d1(n) is mapped over d OFDM symbols. The index u of the first synchronization signal sequence d1(n) mapped over d OFDM symbols is selected from any of x1 indices u (x1=3 in FIG. 1). The first synchronization signal sequence d1(n) mapped over d OFDM symbols is aligned in the time domain in s1 rows. In set 3, the number of cell IDs specified by the first synchronization signal is s1*x1.

As describe above, in set 1 to set 3 in FIG. 18 and FIG. 19, the number of resource elements to which the synchronization signals are mapped is constant. This can prevent the synchronization acquisition accuracy from deteriorating due to the sampling error even in the case that the sampling frequency/OFDM symbol length/the number of FFT points of the radio parameter sets are different. Each of the base synchronization signal sequences d1(n) combined is configured with a root. In each radio parameter set, the cell ID is specified by a series of synchronization signals constituted by the combination of the base synchronization signal sequences. This increases the number of cell IDs specified by the first synchronization signal in set 2 and set 3, which can prevent the accuracy in the synchronization signal acquisition and cell ID detection from deteriorating due to interference from another cell even in the case of dense cell arrangement or rough cell arrangement. The configuration examples of the radio format illustrated in FIG. 16 to FIG. 19 may be applied to the base station apparatus and terminal apparatus illustrated in FIG. 12 to FIG. 14.

A program running on each of the base station apparatus and the terminal apparatus according to an aspect of the present invention is a program (a program for causing a computer to operate) that controls a CPU and the like in such a manner as to realize the functions according to an aspect of the above-described embodiments of the present invention. The information handled by these devices is temporarily held in a RAM at the time of processing, and is then stored in various types of ROMs, HDDs, and the like, and read out by the CPU as necessary to be edited and written. Here, a semiconductor medium (a ROM, a non-volatile memory card, or the like, for example), an optical recording medium (DVD, MO, MD, CD, BD, or the like, for example), a magnetic recording medium (a magnetic tape, a flexible disk, or the like, for example), and the like can be given as examples of recording media for storing the programs. In addition to realizing the functions of the above-described embodiments by performing loaded programs, functions according to an aspect of the present invention can be realized by the programs running cooperatively with an operating system, other application programs, or the like in accordance with instructions included in those programs.

In a case of delivering these programs to market, the programs can be stored in a portable recording medium, or transferred to a server computer connected via a network such as the Internet. In this case, storage devices in the server computer are also included in an aspect of the present invention. Furthermore, some or all portions of each of the terminal apparatus and the base station apparatus in the above-described embodiments may be realized as LSI, which is a typical integrated circuit. The functional blocks of the reception device may be individually realized as chips, or may be partially or completely integrated into a chip. In a case that the functional blocks are integrated into a chip, an integrated circuit control unit for controlling them is added.

The circuit integration technique is not limited to LSI, and the integrated circuits for the functional blocks may be realized as dedicated circuits or a multi-purpose processor. Furthermore, in a case where with advances in semiconductor technology, a circuit integration technology with which an LSI is replaced appears, it is also possible to use an integrated circuit based on the technology.

Note that the invention of the present patent application is not limited to the above-described embodiments. The terminal apparatus according to the invention of the present patent application is not limited to the application in the mobile station device, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the claims.

### INDUSTRIAL APPLICABILITY

The present invention can be preferably used in a base station apparatus, a terminal apparatus, and a communication method.

The present international application claims priority based on JP 2015-215431 filed on Nov. 2, 2015, and all the contents of JP 2015-215431 are incorporated in the present international application by reference.

### DESCRIPTION OF REFERENCE NUMERALS

10, 10-1, 10-2, 11, 11-1, 11-2, 12, 12-1 to 12-5 Base station apparatus
20, 20-1, 20-2 Terminal apparatus
101 Higher layer processing unit
102 Control unit
103 Transmission unit
104 Reception unit
105 Transmit and/or receive antenna
1011 Radio resource control unit
1012 Scheduling unit
1031 Coding unit
1032 Modulation unit
1033 Downlink reference signal generation unit
1034 Multiplexing unit
1035-1 to 1035-3 Radio transmission unit
1036 Synchronization signal generation unit
1041-1 to 1041-3 Radio reception unit
1042 Demultiplexing unit
1043 Demodulation unit
1044 Decoding unit
201 Higher layer processing unit
202 Control unit
203 Transmission unit
204 Reception unit
205 Channel state information generating unit
206 Transmit and/or receive antenna
2011 Radio resource control unit
2012 Scheduling information interpretation unit
2031 Coding unit
2032 Modulation unit
2033 Uplink reference signal generation unit
2034 Multiplexing unit
2035-1 to 2035-3 Radio transmission unit
2041-1 to 2041-3 Radio reception unit
2042 Demultiplexing unit
2043 Signal detection unit
2044 Synchronization detecting unit

1. A terminal apparatus for performing OFDM communication with a base station apparatus, the terminal apparatus comprising:
a radio reception unit configured to receive downlink signals in a frequency band, the frequency band being constituted by a region of a first radio parameter set and a region of a second radio parameter having a subcarrier spacing different from a subcarrier spacing of the first radio parameter set; and
a synchronization detecting unit configured to establish synchronization with the base station apparatus in the frequency band, wherein
a synchronization signal sequence of the first radio parameter set is mapped to the region of the first radio parameter set, and a synchronization signal sequence of the second radio parameter set is mapped to the region of the second radio parameter set, and
the synchronization detecting unit detects synchronization with the base station apparatus in the frequency band by using the synchronization signal sequence of the first radio parameter set and the synchronization signal sequence of the second radio parameter set.

2. The terminal apparatus according to claim 1, wherein
in a case that the synchronization detecting unit establishes synchronization by using the synchronization signal sequence of the first radio parameter set, the radio reception unit receives information on a synchronization signal sequence of the second parameter set included in the downlink signals mapped to the region of the first radio parameter set, and
the synchronization detecting unit detects synchronization in the region of the second parameter set by using the information on the synchronization signal sequence of the second parameter set.

3. The terminal apparatus according to claim 1, wherein
in a case that the synchronization detecting unit establishes synchronization by using the synchronization signal sequence of the first radio parameter set, the radio reception unit uses the synchronization established by using the synchronization signal sequence of the first radio parameter set to receive downlink signals transmitted by the base station apparatus, in the region of the first radio parameter set and the region of the second radio parameter set.

4. The terminal apparatus according to claim 1, wherein
the synchronization signal sequence of the second radio parameter set is a sequence obtained by combining synchronization signal sequences of multiple first radio parameter sets, and the synchronization signal sequence of each of the first radio parameter sets constituting a synchronization signal of the second radio parameter set is any sequence of multiple synchronization signal sequence candidates, and
the synchronization detecting unit detects a cell ID of the second radio parameter set from a series of synchronization signal sequences obtained by combining the synchronization signal sequences of the multiple first radio parameter sets.

5. The terminal apparatus according to claim 1, wherein
in a case that the subcarrier spacing of the first radio parameter set is a times the subcarrier spacing of the second radio parameter set, the synchronization detecting unit detects synchronization in the region of the second radio parameter set by using the number of OFDM symbols which is a times the number of OFDM symbols that the synchronization signal sequence of the first radio parameter set is mapped.

6. The terminal apparatus according claim 1, wherein
the synchronization detecting unit uses the number of subcarriers that is the same as the number of subcarriers used to detect synchronization in the region of the first radio parameter set to detect synchronization in the region of the second radio parameter set.

7. The terminal apparatus according to claim 1, wherein
each of the first radio parameter set and the second radio parameter set is one radio access technology.

8. A communication method of a terminal apparatus for performing OFDM communication with a base station apparatus, the communication method comprising the steps of:
receiving downlink signals in a frequency band, the frequency band being constituted by a region of a first radio parameter set and a region of a second radio parameter set having a subcarrier spacing different from a subcarrier spacing of the first radio parameter set; and
establishing synchronization with the base station apparatus in the frequency band, wherein
a synchronization signal sequence of the first radio parameter set is mapped to the region of the first radio parameter set, and a synchronization signal sequence of the second radio parameter set is mapped to the region of the second radio parameter set, and
the detecting detects synchronization with the base station apparatus in the frequency band by using the synchronization signal sequence of the first radio parameter set and the synchronization signal sequence of the second radio parameter set.

9. A base station apparatus for performing OFDM communication with a terminal apparatus, the base station apparatus comprising:
a synchronization signal generation unit configured to generate a synchronization signal sequence of a first radio parameter set and a synchronization signal sequence of a second radio parameter set;
a multiplexing unit configured to, in a frequency band constituted by a region of the first radio parameter set and a region of the second radio parameter set having a subcarrier spacing different from a subcarrier spacing of the first radio parameter set, map the synchronization signal sequence of the first radio parameter set to the region of the first radio parameter set and map the synchronization signal sequence of the second radio parameter set to the region of the second radio parameter set;
a radio transmission unit configured to transmit the synchronization signal sequence of the first radio parameter set and the synchronization signal sequence of the second radio parameter set to the terminal apparatus; and
a radio reception unit configured to receive an uplink signal from the terminal apparatus, wherein
in a case that the radio reception unit receives information indicating that synchronization is established in any radio parameter set, the radio transmission unit transmits information on a synchronization signal sequence of other radio parameter set than the radio parameter set specified by the information indicating that the synchronization is established.

10. A base station apparatus for performing OFDM communication with a terminal apparatus, the base station apparatus comprising:
a synchronization signal generation unit configured to generate a synchronization signal sequence of a first radio parameter set and a synchronization signal sequence of a second radio parameter set;
a multiplexing unit configured to, in a frequency band constituted by a region of the first radio parameter set and a region of the second radio parameter set having a subcarrier spacing different from a subcarrier spacing of the first radio parameter set, map the synchronization signal sequence of the first radio parameter set to the region of the first radio parameter set and map the synchronization signal sequence of the second radio parameter set to the region of the second radio parameter set; and
a radio transmission unit configured to transmit the synchronization signal sequence of the first radio parameter set and the synchronization signal sequence of the second radio parameter set to the terminal apparatus, wherein
the number of OFDM symbols that the synchronization signal sequence of the second radio parameter set is mapped by the multiplexing unit is configured to be more than the number of OFDM symbols that the synchronization signal sequence of the first radio parameter set is mapped.

11. The base station apparatus according to claim 10, wherein
in a case that the subcarrier spacing of the first radio parameter set is a times the subcarrier spacing of the second radio parameter set, the number of OFDM symbols that the synchronization signal sequence of the second radio parameter set is mapped is a times the number of OFDM symbols that the synchronization signal sequence of the first radio parameter set is mapped.

12. The base station apparatus according to claim 10, wherein
the number of subcarriers that the synchronization signal sequence of the first radio parameter set is mapped is the same as the number of subcarriers that the synchronization signal sequence of the second radio parameter set is mapped.

13. The base station apparatus according to claim 12, wherein
the number of subcarriers that the first radio parameter set is mapped is the same as the number of subcarriers constituting a system band of the second radio parameter set.

14. The base station apparatus according to claim 10, wherein
a frequency bandwidth that a synchronization signal of the first radio parameter set is mapped is the same as a frequency bandwidth that a synchronization signal of the second radio parameter set is mapped.

15. The base station apparatus according to claim 10, wherein
the synchronization signal generation unit generates the synchronization signal sequence of the second radio parameter set by combining synchronization signal sequences of multiple first radio parameter sets, and each of the synchronization signal sequences of the first radio parameter sets constituting the synchronization signal of the second radio parameter set is a synchronization signal sequence selected from multiple synchronization signal sequence candidates.

16. A communication method of a base station apparatus for performing OFDM communication with a terminal apparatus, the communication method comprising the steps of:
generating a synchronization signal sequence of a first radio parameter set and a synchronization signal sequence of a second radio parameter set;
in a frequency band constituted by a region of the first radio parameter set and a region of the second radio parameter set having a subcarrier spacing different from a subcarrier spacing of the first radio parameter set, mapping the synchronization signal sequence of the first radio parameter set to the region of the first radio parameter set and mapping the synchronization signal sequence of the second radio parameter set to the region of the second radio parameter set;
transmitting the synchronization signal sequence of the first radio parameter set and the synchronization signal sequence of the second radio parameter set to the terminal apparatus; and
receiving an uplink signal from the terminal apparatus, wherein
in a case that the receiving receives information indicating that synchronization is established in any radio parameter set, the transmitting transmits information on a synchronization signal sequence of other radio parameter set than the radio parameter set specified by the information indicating that the synchronization is established.
